(19) United States
(12) Patent Application Publication
(10) Pub. No.: US 2011/0268883 A1
(43) Pub. Date: Nov. 3, 2011

(54) Force curve analysis method for planar object leveling

(75) Inventors: Jason R. Haaheim, Chicago, IL (US); John Edward Bussan, Naperville, IL (US); Edward R. Solheim, Mount Prospect, IL (US); John Moskal, Chicago, IL (US); Michael R. Nelson, Libertyville, IL (US); Vadim Val-Khvalabov, Chicago, IL (US)

(73) Assignee: Nanolnk, Inc.

(21) Appl. No.: 13/064,926

(22) Filed: Apr. 26, 2011

Related U.S. Application Data
(60) Provisional application No. 61/328,557, filed on Apr. 27, 2010.

(51) Int. Cl. B05D 5/00; B05C 13/00

(52) U.S. Cl. 427/256; 118/663; 414/816

(57) ABSTRACT

An apparatus for leveling an array of microscopic pens relative to a substrate surface or measuring a relative tilting therebetween includes an actuator configured to drive one of the array or the substrate to vary a distance therebetween, one or more force sensors configured to measure a force between the array and the surface, and a device configured calculate a force curve parameter of the force over the distance or time. The apparatus is configured to level the array relative to the surface by varying a relative tilting between the array and the substrate surface based on the force curve parameter or to measure the relative tilting based on the force curve parameter. Methods and software also are provided.

### CROSS-REFERENCE TO RELATED APPLICATIONS

This application claims priority from U.S. Provisional Application No. 61/328,557, filed Apr. 27, 2010, which is hereby incorporated by reference in its entirety.

### BACKGROUND

Microscale tips and nanoscale tips can be used for high resolution patterning, imaging, and data storage. In patterning or printing, an ink or patterning compound can be transferred from the tip to a surface such as a substrate surface. For example, the tip can be an atomic force microscope (AFM) tip attached to one end of a cantilever or a larger support structure. Dip-pen nanolithography (DPN) patterning is a promising technology for patterning nanomaterials which can be carried out via different embodiments including use of AFM tips and cantilevers. In another embodiment of DPN patterning, array based patterning can be carried out which can involve a cantilever-free lithographic approach that uses elastomeric tips (sometimes called polymer-pen lithography (PPL)).

These direct-write nanolithographic approaches can provide advantages which competing nanolithographies may not provide, such as high registration, throughput, multiplexing, versatility, and lower costs. Various approaches are described in, for example, Mirkin et al, WO 00/41213; WO01/91855; U.S. Patent Application Pub. No. 2009/0325816; Small, 2005, 10, 940-945; Small, 200901538; See also U.S. Pat. Nos. 7,005,378; 7,034,854; 7,060,977; 7,098,056; and 7,102,656; and U.S. Patent Application Pub. No. 2009/0205091 to NanoInk.

In many applications, 1D or 2D arrays of such tips are used. As the tip arrays become more geometrically complex and larger with more tips, leveling of the array becomes more difficult. If the array is not level with the substrate surface, one tip may touch the surface before another tip touches the surface, or the other tip may not even touch the surface at all. It may also be difficult to know when the tips touch the surface. In many cases, it is desired that most or all of the tips are in contact with the surface when writing, and most or all are off the surface when not writing.

Once the two dimensional spatial profile of the array is established, it is desirable to have a high degree of planarity for the 2D array of tips or cantilever tips; otherwise, during lithography cantilevers and tips can be damaged or writing may not become satisfactory.

An example of prior methods for leveling is provided in Liao et al., “Force-Feedback Leveling of Massively Parallel Arrays in Polymer Pen Lithography”, Nano Lett., 2010, 10(4), 1335-1340.

### SUMMARY

Embodiments described herein include, for example, devices, instruments, and systems, methods of making devices, instruments, and systems, and methods of using devices, instruments, and systems. Computer readable media, hardware, and software are also provided. Kits are also provided. Kits can comprise instruction materials for using instruments, devices, and systems.

Embodiments disclosed herein are directed, for example, to a device.

One embodiment provides, for example, an apparatus configured to level an array of microscopic pens relative to a substrate surface, the apparatus comprising: an actuator configured to drive one of the array or the substrate surface to vary at least one of a first relative distance or a relative tilting therebetween over time; one or more force sensors configured to measure a force between the array and the substrate surface; and a device configured to calculate a derivative of one of the force or a second distance over the first distance or time; wherein the apparatus is configured to perform at least one of: leveling the array relative to the substrate surface by varying a relative tilting between the array and the substrate surface based on the derivative; or measuring the relative tilting based on the derivative.

Another embodiment provides a method comprising: varying at least one of a first relative distance and a relative tilting over time between a first object and a second object; obtaining a derivative of force or a second relative distance between the first and second objects over the first relative distance or over a time; and based on the derivative, adjusting a relative tilting between the first and second objects or measuring the relative tilting.

Another embodiment provides, for example, a non-transistory computer-readable medium storing instructions thereon, wherein the instructions include: obtaining over time a plurality of first distances between a first object and a second object; obtaining a derivative of a force or a second distance between the first and second objects over the first distance or over a time; and based on the derivative, controlling a relative tilting between the first and second objects, or obtaining the relative tilting.

Another embodiment provides a method comprising: providing at least one array of tips coated with an ink, providing at least one substrate, moving at least one of the tips or the substrate so that ink is transferred from the tips to the substrate, wherein the moving comprises the step of leveling the array and the substrate with use of force-distance measurements including derivative calculation.

Another embodiment provides a method comprising: providing a substrate surface; providing at least one array of pens; providing an actuator configured to drive one of the array and/or the substrate surface to vary a distance therebetween over time; providing a force sensor configured to measure a force between the array and the substrate surface; and providing a device configured to calculate a derivative of the force over the distance or time; driving at least one of the array or the substrate surface to vary the distance therebetween over time; measuring a force between the array and the substrate surface; calculating a derivative of the force over the distance or time; and performing at least one of: (1) leveling the array relative to the substrate surface by varying a relative tilting between the array and the substrate surface based on the derivative; or (2) measure the relative tilting based on the derivative.

Another embodiment provides, for example, a method comprising: predicting a force-distance relationship between a first and second objects; varying a distance between the first and second objects based on the force-distance relationship; and obtaining a derivative of force with respect to the distance; and based on the derivative, leveling the first and second objects or measuring a relative tilting between the first and second objects.

Another embodiment provides, for example, an automatic, adaptive leveling method comprising: continuously obtaining a derivative from a force-distance, a distance-distance, a distance-time, or a force-time relationship between two objects; and continuously adjusting a relative tilting between the two objects based on the derivative in real time.

Another embodiment provides, for example, an apparatus configured to level an array of microscopic pens relative to a substrate surface, the apparatus comprising: an actuator configured to drive one of the array or the substrate surface to vary at least one of a first relative distance or a relative tilting therebetween over time; one or more force sensors configured to measure a force between the array and the substrate surface; and a device configured to calculate a force curve parameter of a curve of one of the force or a second distance over the first distance or time; wherein the apparatus is configured to perform at least one of: leveling the array relative to the substrate surface by varying a relative tilting between the array and the substrate surface based on the force curve parameter; or measuring the relative tilting based on the force curve parameter.

Another embodiment provides, for example, a method comprising: varying at least one of a first relative distance and a relative tilting over time between a first object and a second object; obtaining a force curve parameter of a curve of one of the force or a second relative distance between the first and second objects over the first relative distance or over a time; and based on the force curve parameter, adjusting a relative tilting between the first and second objects or measuring the relative tilting.

Another embodiment provides, for example, a non-transistory computer-readable medium storing instructions thereon, wherein the instructions include: obtaining over time a plurality of first distances between a first object and a second object; obtaining a force curve parameter of a curve of one of a force or a second distance between the first and second objects over the first distance or over a time; and based on the force curve parameter, controlling a relative tilting between the first and second objects, or obtaining the relative tilting.

Another embodiment provides, for example, a method comprising: providing at least one array of tips coated with an ink, providing at least one substrate, moving at least one of the tips or the substrate so that ink is transferred from the tips to the substrate, wherein the moving comprises the step of leveling the array and the substrate with use of force-distance measurements including a calculation of a force curve parameter of a force curve.

Another embodiment provides, for example, a method comprising: providing a substrate surface; providing at least one array of pens; providing an actuator configured to drive one of the array and/or the substrate surface to vary a distance therebetween over time; providing a force sensor configured to measure a force between the array and the substrate surface; and providing a device configured to calculate a force curve parameter of a curve of the force over the distance or time; driving at least one of the array or the substrate surface to vary the distance therebetween over time; measuring a force between the array and the substrate surface; calculating a force curve parameter of the force over the distance or time; and performing at least one of: (1) leveling the array relative to the substrate surface by varying a relative tilting between the array and the substrate surface based on the force curve parameter; or (2) measuring the relative tilting based on the force curve parameter.

Another embodiment provides, for example, a method comprising: predicting a force-distance relationship between a first and second objects; varying a distance between the first and second objects based on the force-distance relationship; and obtaining a force curve parameter of a curve of force with respect to the distance; and based on the force curve parameter, leveling the first and second objects or measuring a relative tilting between the first and second objects.

Another embodiment provides, for example, an automatic, adaptive leveling method comprising: continuously obtaining a force curve parameter from a force-distance curve, a distance-distance curve, a distance-time curve, or a force-time curve of a relationship between two objects; and continuously adjusting a relative tilting between the two objects based on the force curve parameter in real time.

At least one advantage for at least one embodiment comprises better leveling, patterning, and/or imaging. Leveling, patterning, and/or imaging can be faster and more reproducible, for example.

### BRIEF DESCRIPTION OF FIGURES

FIG. 1A is a side view of a system for leveling or for measuring a surface planarity.

FIG. 1B is a perspective view a system for leveling or for measuring a surface planarity.

FIG. 1C is a schematic diagram showing a perfectly planar 2D nano PrintArray (2D nPA® by NanoInk) at the initial point of contact, and after 6 μm of deflection grounding out on the standoffs. In this embodiment, the freedom of travel (F.O.T.) was 6 μm.

FIGS. 1D and 1E are schematic diagrams of a scenario where the 2D nPA approaches the limit of angular tolerance.

FIG. 1F is a schematic diagram illustrating a planarity with respect to an array chip and a substrate, and the parameters used to define thereof.

FIG. 2A is a flow chart for an automatic leveling process.

FIG. 2B is a flow chart for an process including adaptive leveling.

FIG. 3A illustrates the basic principle of obtaining derivatives.

FIGS. 3B and 3C illustrate various force curves and their derivatives.

FIGS. 4A and 4B show force-distance curves for the 2D nPA interacting with the substrate at its initial planarity (no Tₓ, T_{y} adjustments).

FIGS. 5A and 5B show the force-distance curves for an Elastomeric Polymer Tip (EPT) array (fabricated on a transparent glass backing-substrate).

FIGS. 6A-6C show the collection of force curves for the 2D nPA collected at various Tₓ positions.

FIGS. 7A-7C show the collection of force curves for the EPT array collected at various Tx positions.

FIGS. 8A-8C show force-distance curve measurements of the OHaus scale against a rigid object, verifying that the scale itself behaves in a linear way, and therefore would not compromise any subsequent system measurements.

FIG. 9A is a flow chart for an automatic leveling process using force curve analysis.

FIG. 9B is a flow chart for a process including adaptive leveling using force curve analysis.

FIG. 10A shows a top perspective view of an embodiment of a load-cell chassis that may be used in a ball-spacer apparatus.

FIG. 10B shows a top perspective view of a load-cell digitizer that may be included in the embodiment of the load-cell chassis depicted in FIG. 10A.

FIG. 10C shows an exploded bottom perspective view of a load-cell digitizer located in the embodiment of the load-cell chassis depicted in FIG. 10A.

FIG. 10D shows a top perspective view of a mounting block of the embodiment of the load-cell chassis depicted in FIG. 10A.

FIG. 10E shows an exploded top perspective view of the embodiment of the load-cell chassis depicted in FIG. 10A.

FIG. 11A shows a three-axis plot of a collection of force curves for a 48 tip 1D array collected at various T_{y} positions for a coarse sweep where the array is driven in a stepwise manner.

FIG. 11B shows a three-axis plot of a collection of force curves for a 48 tip 1D array collected at various T_{y} positions for a finer sweep where the array is driven in a stepwise manner.

FIG. 12 shows a three-axis plot of a collection of force curves for a 48 tip 1D array collected at various T_{y} positions for a coarse sweep where the array is driven in a continuous manner.

FIG. 13 shows a three-axis plot of a collection of force curves for a 48 tip 1D array collected at various T_{y} positions for a finer sweep where the array is driven in a continuous manner.

FIG. 14 shows a three-axis plot of a collection of force curves for a 48 tip 1D array collected at various T_{y} positions illustrating “wings”.

FIG. 15 shows the load vs. the displacement for determining the threshold slope for rejecting data.

FIG. 16 shows a three-axis plot of the data of FIG. 14 with a larger scale for the force integral.

FIG. 17 shows a three-axis plot of the data of FIGS. 14 and 15 with the wings removed and the data truncated.

FIG. 18 shows a three-axis plot of a collection of force curves for a 12 tip 1D array collected at various T_{y} positions.

FIG. 19 shows k values for silicon chips vs. the PDMS chips.

FIG. 20 is a histogram showing the repeatability of the identification of the tilt parameter T_{y} for a peak force curve integral.

FIG. 21 depicts a 5 mm by 5 mm area that has been printed with an array that is not perfectly parallel to a substrate surface.

FIG. 22 depicts a 5 mm by 5 mm area that has been printed after the substrate was leveled to the array using the above-described method.

### DETAILED DESCRIPTION

### Introduction

This application is related to application entitled “Ball-Spacer Method for Planar Object Leveling” filed concurrently herewith, Ser. No. ______, (attorney docket no. 083847-0739), which is incorporated herein by reference.

All references cited in this application are hereby incorporated by reference in their entirety. The following references may aid the understanding and/or practicing the embodiments disclosed herein:

Haaheim et al., Self-Leveling Two Dimensional Probe Arrays for Dip Pen Nanolithography®, Scanning, 2010 (in press);

Salaita K. S., Wang Y. H., Fragala J., Vega R. A., Liu C., Mirkin C. A.: Massively parallel dip-pen nanolithography with 55000-pen two-dimensional arrays, Angewandte Chemie-International Edition 45, 7220-7223 (2006);

Huo et al., Polymer Pen Lithography, Science 321 1658-1660 (2008);

NanoInk U.S. Patent Application Pub. Nos. 2008/0055598: “Using Optical Deflection of Cantilevers for Alignment,” 2008/0309688: “Nanolithography with use of Viewports;” 2009/0023607: “Compact nanofabrication apparatus;” 2009/0205091: “Array and cantilever array leveling;” Provisional Application Nos. 61/026,196, “Cantilever Array Leveling,” and 61/226,579, “Leveling Devices and Methods;”

other U.S. Patent Application Pub. Nos. 2005/0084613: “Sub-micron-scale patterning method and system;” 2005/0160934: “Materials and methods for imprint lithography;” 2.010/0089869: “Nanomanufacturing devices and methods;” 2009/0325816: “Massively parallel lithography with two-dimensional pen arrays;” 2009/0133169: “Independently-addressable, self-correcting inking for cantilever arrays,” 2008/0182079: “Etching and hole arrays;” 2008/0105042: “Massively parallel lithography with two-dimensional pen arrays;” 2007/0087172: “Phase separation in patterned structures,” 2003/0007242: “Enhanced scanning probe microscope and nanolithographic methods using the same.”

### Leveling

Leveling generally involves making a first generally flat surface to be substantially parallel to a second generally flat surface. In the applications of nanoscopic or microscopic patterning, printing, or imaging, the first surface is usually a plane defined by an array of tips, and the second surface can be a substrate surface on which the pattern is formed.

For DPN-related technologies, including PPL technologies, leveling is particularly important to successful nanoscale patterning once the printing system is beyond a single tip/cantilever system. In order to ensure uniform patterning, 1D arrays of tips must be substantially level with the surface over which the pattern to be printed.

Embodiments disclosed herein relate to methods for planar object leveling, wherein two planar objects can be leveled relative to each other, particularly when either or both comprise a compressible or flexible material or object with compressible/flexible elements. In some embodiments, the tips of the DPN printing can be substantially rigid, while the tips are disposed on a flexible/compressible backing Embodiments disclosed herein can apply not only to DPN printing from tips (made of SiN, PDMS, etc.), but also apply to any compressible/flexible objects or objects with compressible/flexible components, such as flexible/springy cantilevers, rubbery PDMS tips, a box spring mattress, a μCP stamp, or even a kitchen sponge.

In some embodiments, leveling is carried out with at least 16, or at least 100, or at least 1,000, or at least 10,000, or at least 100,000, or at least 1,000,000 tips on a single array.

In some embodiments, leveling is such that at least 80% of the tips are in contact with the substrate surface, or at least 90%, or at least 95%, or at least 98%, or at least 99% of the tips are in contact with the surface. Contact can be determined by what percentage of the tips generating patterning may transfer of material from the tip to the substrate.

Examples of square area for arrays to be leveled include, for example, at least 1 square μm, at least 500 square μm, or at least one square cm, or at least ten square cm, or at least 50 square cm, for example, can be many square meters.

### Derivative Introduction

In accordance with an embodiment, an approach for leveling between two surfaces of two objects or measuring the planarity or tilting angles of a surface employs varying a relative distance between the surfaces and obtaining a derivative of force to the distance. Distance can be also expressed as a function of time. Alternatively, the derivative can be obtained for a first distance and a second distance, wherein the first and second distances include, for example, an actuation distance or a response distance, as described in detail below. The derivative between the first and second distances is related to the force derivative, and thus can be used for leveling as well.

The distance can be varied, for example, at a constant rate, using an actuator that drives one or both of the objects. The force between the probes and the surface can be measured as a function of the distance. When the probes and the substrate surface are not perfectly level, one of the probes may come into contact with the surface first, with progressively more probes contacting the surface as the distance becomes smaller, resulting in an increase in the feedback force that can be measured.

A derivative of the force over the distance can be calculated. If the probes and the surface are relatively level with each other, as the distance between them changes, a change in force, i.e., a derivative of the force, will be faster compared with the case that there is a larger tilting between the probes and the surface.

Mathematically, this manifests as measuring the derivative of force to the distance and finding its maximum value φ₀:

$${φ}_{0} ∝ \frac{d F}{d {z}_{ma x }} ,$$

which indicates a desired level position. By changing a tilting between the probes and the surface, and repeatedly measuring the above force derivative, the force derivatives can be plotted as a function of the tilting in both x (Tₓ) and y (T_{y}) directions. By finding the maximum value of the derivatives, the best leveling can be achieved.

The leveling system in accordance with embodiments disclosed herein can have an actuator to drive a backing of the probes, or to drive the substrate, to have a constant change in their relative distance, i.e., dZ/dt=constant. Subsequently, one has

$${φ}_{0} ∝ \frac{d F}{d {t}_{ma x}} .$$

In accordance with some embodiments, the derivative can be an n-th order derivative, wherein n is an integer:

$${φ}_{0} ∝ \frac{{d}^{n} F}{d {z}^{n}}$$

In systems where the force (F) exerted by the compressible/flexible material varies non-linearly, the higher-order derivatives better characterize the leveling. In particular, taking a series of n derivatives greater-than-or-equal to the power of the force (m) dependence will eventually yield a single constant (C_{final}) for n≧m such that:

$$F ( z ) = - {C}_{0} k \cdot {z}^{m} … ⇒ {φ}_{0} ∝ \frac{{d}^{n} F ( z )}{d {z}^{n}} = - {C}_{1} \cdot \frac{{d}^{n} {z}^{m}}{d {z}^{n}} = - {C}_{2} \cdot {mz}^{m - 1} + - {C}_{3} \cdot ( m - 1 ) {z}^{m - 2} + … = {C}_{final}$$

For example, if F is proportional to z³, differentiating the curve once yields a parabola. The second-order derivative yields an upward sloping line. The third-order derivative yields a constant value.

Regardless of the complexity of the original curve, it can always be turned into a collection of constants through a sufficient number of differentiations. This collection of constants (C_{final}) can indicate the force-maximum, and the force-maximum can be highest for the largest values of the constants. In other words, the system will have achieved a maximum planarity when C_{final}=Cₘₐₓ.

Along the way, the various force curves (linear or nonlinear) provide a richly detailed spectrum that describes a material's (or collection of components') compression characteristics. Applying successive differentiation to these force curves yields quantitative information which can be meaningfully compared, and can be used when dealing with the same material/object in order to have “smart-iterative” push-button leveling automation. The automation becomes possible because the force derivative methods (FDM) allow leveling or measuring the tilting from any linear or non-linear compressible material or collection of components.

### Distance Variation and Measurement

Various measurements or definitions about the distance variation can be made for a leveling system. For example, two different z-displacement values can be defined: z_{actuation} and zᵣₑₛₚₒₙₛₑ. The z_{actuation} can be the z-travel measured by an actuating stage (e.g., which can be accurate to +/−5 nm). This is different from the resultant motion of any arrays, materials, compressible objects, or other objects comprising them. The zᵣₑₛₚₒₙₛₑ indicates the amount that the compressible or flexible object compresses or deflects in response to the actuation; this may be subsequently measured by one or more sensors such as capacitive or interferometric sensors.

The force-distance relationships can thus be reformulated as:

$$F ( z ) = - k \cdot z -> F ( {z}_{response} ) = - k \cdot {z}_{response} ; \frac{d F ( z )}{d z} -> \frac{d F ( {z}_{response} )}{d {z}_{actuation}} .$$

By a substitution:

$${φ}_{0} ∝ \frac{d F ( {z}_{response } )}{d {z}_{actuation}} ; {ϕ}_{0} ∝ \frac{d {z}_{response}}{d {z}_{actuation}} ;$$

$$and for constant \frac{d {z}_{actuation}}{d t} , {ϕ}_{0} ∝ \frac{d F ( {z}_{response} )}{d t} ; {ϕ}_{0} ∝ \frac{d {z}_{response}}{d t } ,$$

several additional relationships can be obtained, and the distance variations can be monitored as variations of the “force-derivative method.” For example, dZᵣₑₛₚₒₙₛₑ/dZ_{actuation} indicates the change in one z-value with respect to another, and instead of force/load measurements and force derivatives, the distance variations can be measured, and the derivative of one distance over another can be used for leveling or planarity measurements. This is due to the fact that dZᵣₑₛₚₒₙₛₑ/dZ_{actuation} is closely related to the force derivative as discussed above.

The distance between the two surfaces can be measured optically, or using a capacitive sensor, or can be directly obtained from the controller for the actuator. Like the measurements of the force, the true or absolute distance need not be accurately calibrated. For example, if the measured distance is the true distance multiplied by or added with a constant, the derivative of the measured force to the measured distance can still be used to find the maximum value for leveling.

Actuators, motors, and positioning systems are known in the art, including, for example, nanoscale positioners and piezoelectric actuators.

The device for measuring the distance can be integrated with the force sensor(s) to measure the force feedback and distance simultaneously.

### Leveling System

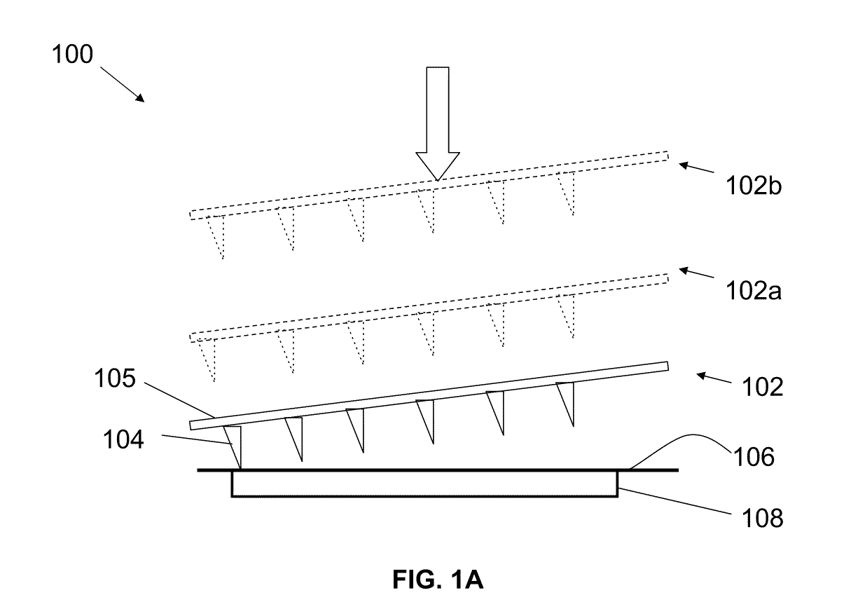

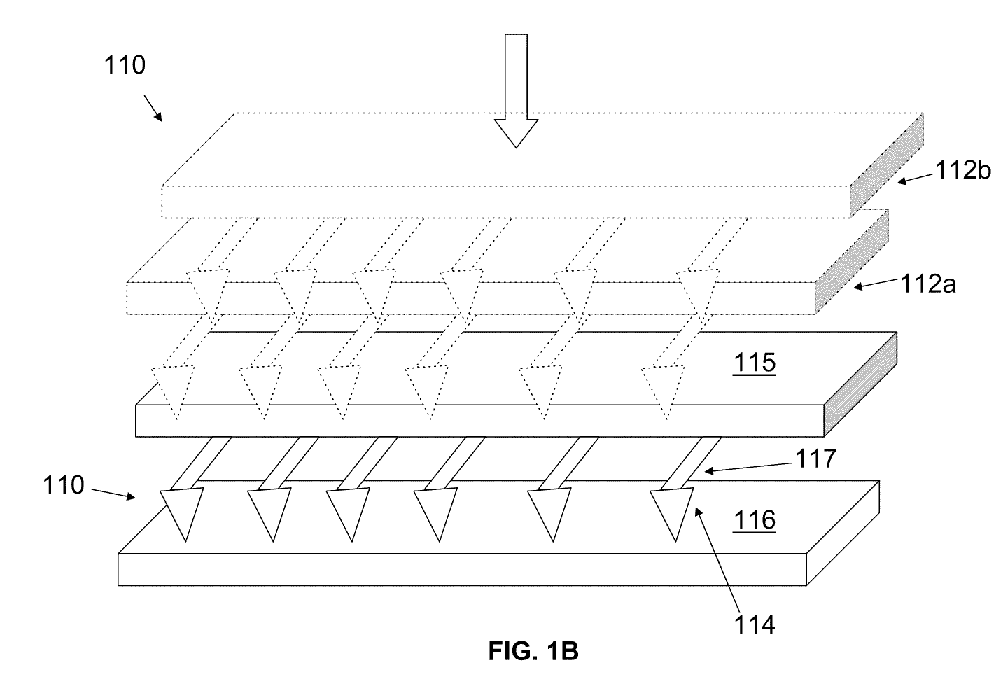

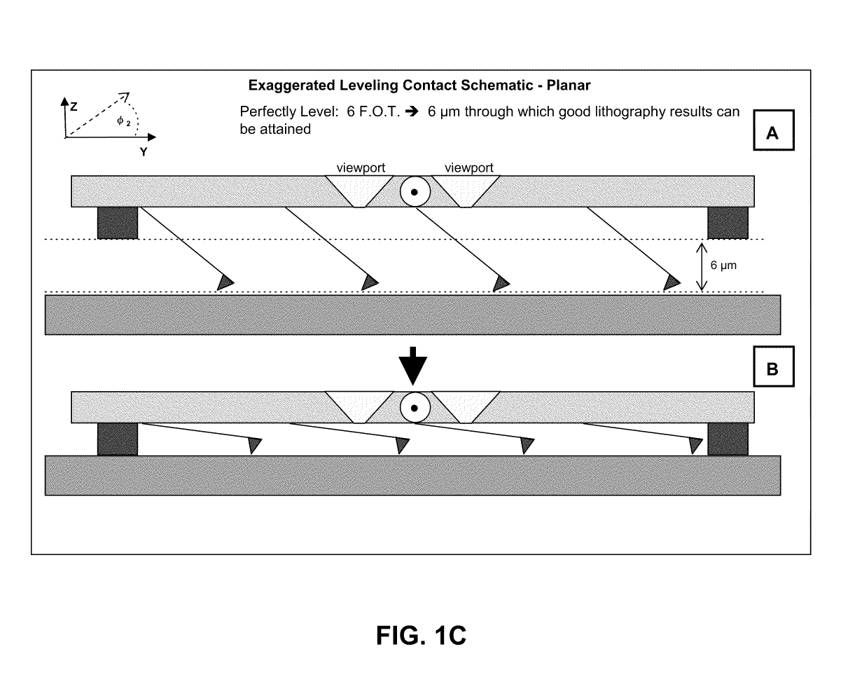

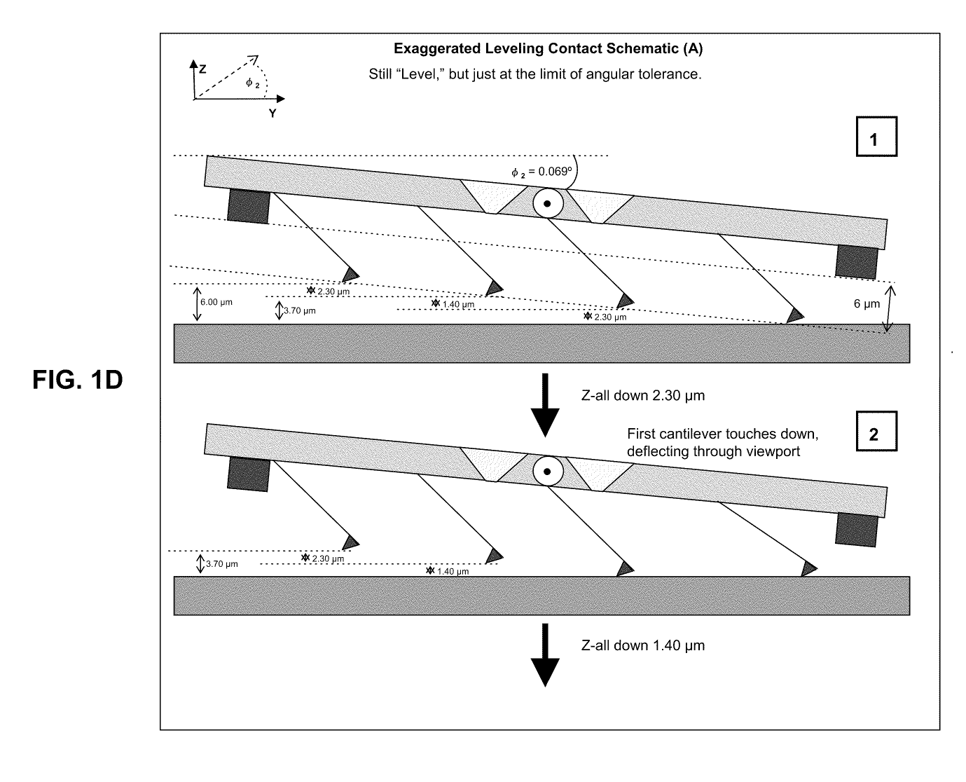

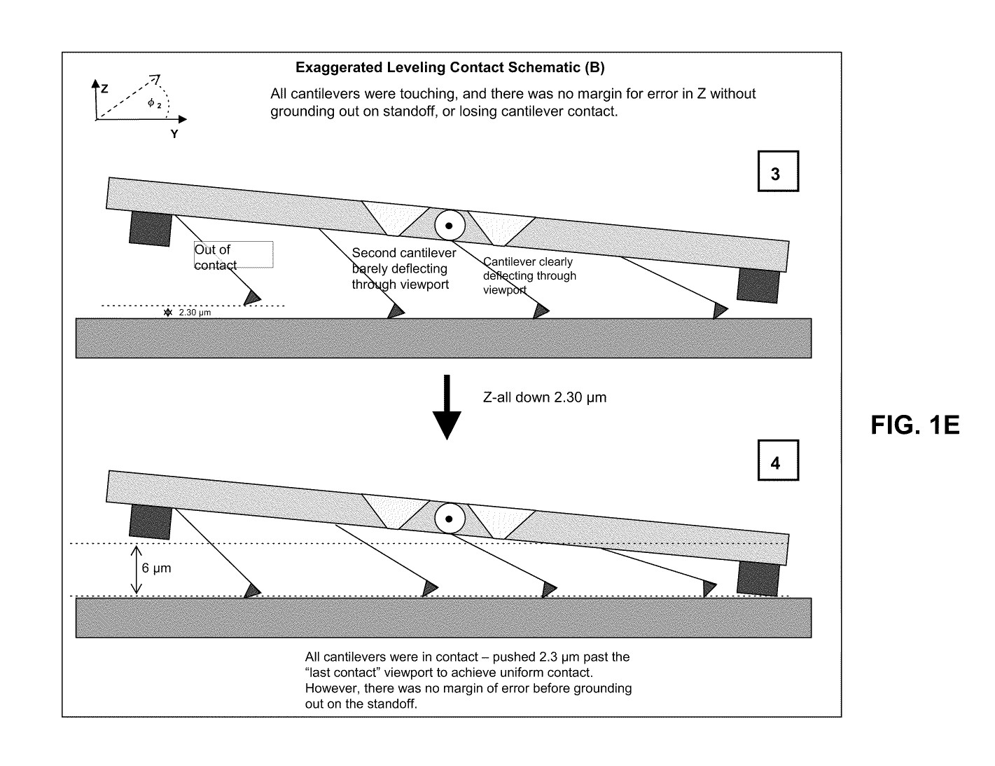

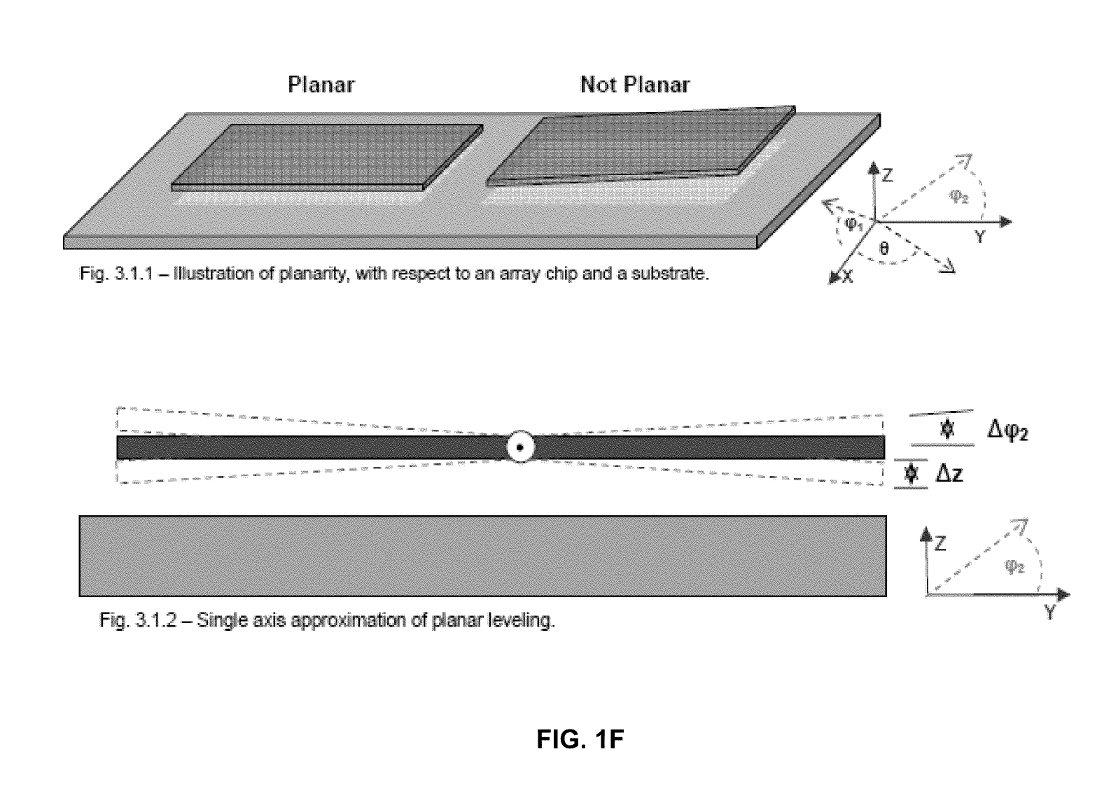

An exemplary system 100 for leveling or for measuring the planarity is illustrated in FIG. 1. In this exemplary embodiment, the array 102 of tips or probes 104 can have a backing 105. The tips can be cantilever-free EPTs, or can be DPN tips disposed over their respective cantilevers. The backing 105 together with the tips can be driven in the z direction by an actuator (not shown), and the feedback force can be measured along the way in a plurality of positions such as 102a, 102b. Note that although in the exaggerated view shown in FIG. 1A at positions 102a, 102b none of the tips 104 touches the substrate surface 106, the force and the relative position between the array 102 and the substrate surface 106 can be measured at a plurality of positions at which at least one of the tips 104 contacts the surface 106 thereby generating a sufficiently large feedback force for measurement by one or more force sensors (not shown). To obtain the derivative, measurements can be made at, for example, at least three positions.

The substrate can be disposed over an actuator such as the Z-stage 108, which can drive the substrate to vary its distance to the plane defined by the tips 104.

FIG. 1B is a perspective view of a system 110 for leveling or for measuring the planarity. In this exemplary embodiment, the array 110 of tips or probes 114 are coupled to a backing 115 through cantilevers 117. Although a 1D array is shown, 2D arrays can be deployed.

The backing 115 together with the tips 114 and cantilevers 117 can be driven in the z direction by an actuator (not shown), and the feedback force can be measured along the way in a plurality of positions such as 112a, 112b. Typically measurements are made in at least three positions to obtain the derivative.

Note again that although in the exaggerated view shown in FIG. 1B at positions 112a, 112b none of the tips 114 touches the substrate surface 116, the force and the relative position between the array 112 and the substrate surface 116 are actually measured at a plurality of positions at which at least one of the tips 114 contacts the surface 116 thereby generating a sufficiently large feedback force for measurement by one or more force sensors (not shown).

At least one of the tips 114, the cantilevers 117, the backing 115, or the substrate surface 116 is compressible or flexible. Preferably only one of these elements, such as the tips 114 or the cantilevers 117, are compressible or flexible, while the other elements in the mechanical loop are substantially rigid, such that the measured force is not a convolution of a plurality of compression/deflection variables.

In the system 100 or 110, the applied force F and its change versus displacement z or time t, are readily measurable, and the relationship between the tilting of the array and the substrate surface is derived from fundamental behaviors of the tips interacting with the surface from first principles in physics, calculus, and basic mechanics. This approach allows the system to be implemented as a rapid automation system.

The methods disclosed herein are not limited to the system 100 that employs EPT. Rather, the methods can be used for DPN, uCP, NIL, standard rubber stamping, different print-transfer methods, flexible electronics printing methods, etc.

The concept of Freedom of Travel (F.O.T.) can be particularly important in the systems. FIG. 1C illustrates this concept for one embodiment in which a planar 2D nano PrintArray (2D nPA® by NanoInk) with 6 μm F.O.T., where (A) illustrates a “feather touch” situation (where the tips are just beginning to touch the substrate), and (B) illustrates the “hard crunch” (where the cantilevers have gone through their full 6 μm freedom of travel, and the array is now grounding out on the standoffs). Thus, in this embodiment, initial z-positioning of anywhere from 0.1 to 5.9 μm within the F.O.T. can yield excellent lithography with uniform contact, while the extreme of 0.0 μm can lead to no writing (i.e., no contact), and 6.0 μm can lead to distorted writing (standoffs grounding out). In other words, in this embodiment, after making first contact (i.e., uniform contact) with the substrate, there was a 6.0 μm margin of error before grounding out on the standoffs.

FIGS. 1D and 1E illustrate a situation where the 2D nPA was not perfectly planar (the tilt angle φ₂≠0°), but still within the tolerance to achieve uniform writing. (1) and (2) show that by the time first contact was observed in the “lowest” viewport, the cantilevers at the edge of the device have already deflected 2.30 μm. Cantilever deflection can be monitored for example by observing how and when the cantilevers naturally change color. According to (3), after another 1.40 μm, the “highest” viewport was deflecting, but there was still another 2.30 μm to deflect until all the cantilevers tips were uniformly touching (4), thereafter there would be no margin of error, and the standoff was nearly touching the substrate.

Because the 2D nPA device is often imperfectly parallel (level) to the substrate, a pertinent question during processing becomes how to achieve and verify uniform contacts of all of the tips, or many or a majority of the tips, without driving the corners of the array into the sample, which would lead to sample scratching, pattern distortion, and/or arraying fishtailing during lithography. The “levelness” (or “planarity”) of the 2D nPA with respect to the substrate can be described in terms of the relative z positions of three distinct points on the 2D nPA as measured by z-axis motors, or as two relative angular difference measurements as measured by goiniometer motors (i.e., φ, θ). A schematic illustration of these parameters is provided in FIG. 1F.

### Automation

A need exists for better automated processes, including both semi- and fully-automated processes.

An automatic leveling system is provided with improved speed for leveling or for planarity/tilting measurements. The automation method does not rely on the need to visualize cantilever deflection for precise leveling, thereby reducing or eliminating the need for human interaction in the process. The automatic system can be operated with a push of a button, and the leveling can be obtained at a predetermined precision or accuracy. Simultaneous quantitative knowledge of the planarity and the applied force or force feedback can be obtained.

In comparison, a conventional method employing manual epoxy attachment technique with a pyrex handle wafer device for leveling may not have the capability of adjusting or fine-tuning the leveling, and may be limited for different substrates. Instrument changes and natural mechanical changes due to stick/slip, thermal expansion/contraction, etc. cannot be taken into account in real time. The pyrex may be heavily etched, and thus roughened, and therefore barely translucent, making it difficult to see the surface or the tips and cantilevers. Thus, it is difficult to judge whether the tips have come into contact with the surface. This limits flexibility of the system in terms of using different samples of different thicknesses, or large samples that are not completely flat. The conventional method also may not be able to align the tips to surface features, such ink wells for multiplexed ink delivery. If may also be difficult to align a laser to the cantilevers for imaging or for measuring the force feedback.

In some methods, evaporated gold can be deposited on the tips in order to observe a light change. However, gold poses limits on the tip chemistry, and also quenches fluorescence while imaging tips. Furthermore, Epoxy takes time (e.g., more than 1 hour) to set, and can bleed ink all over the place, while still introducing volume distortion that affects planarity. This process can also easily contaminate the scanner. If multiplexed ink delivery methods are used to address different inks to different tips, the surface contact time will introduce cross-contamination.

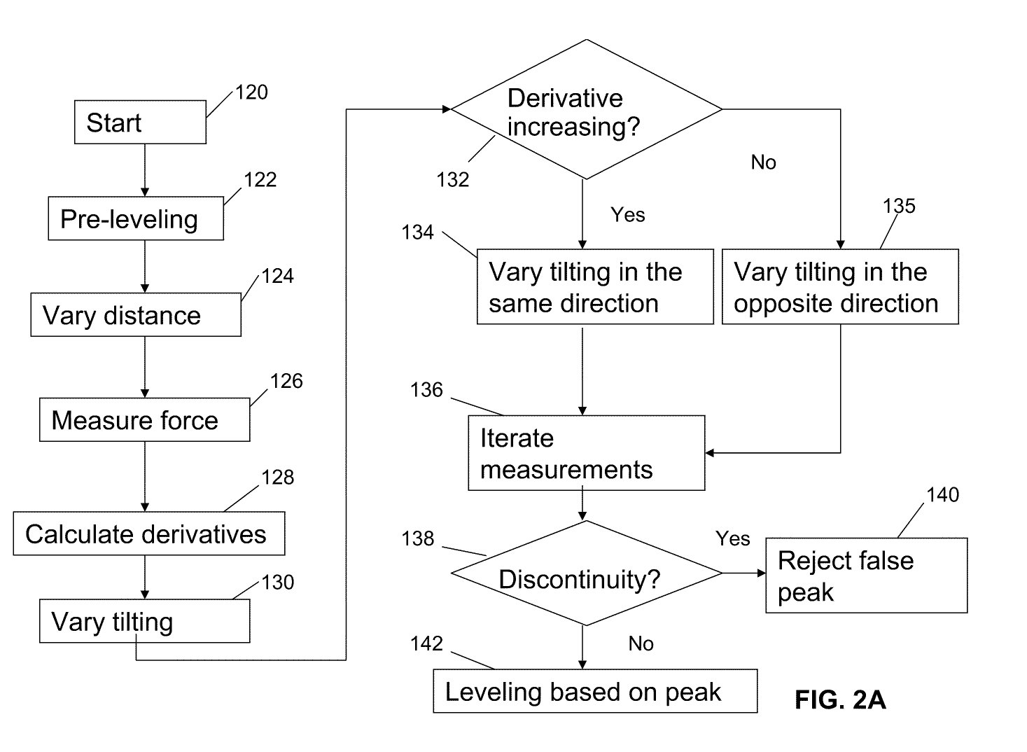

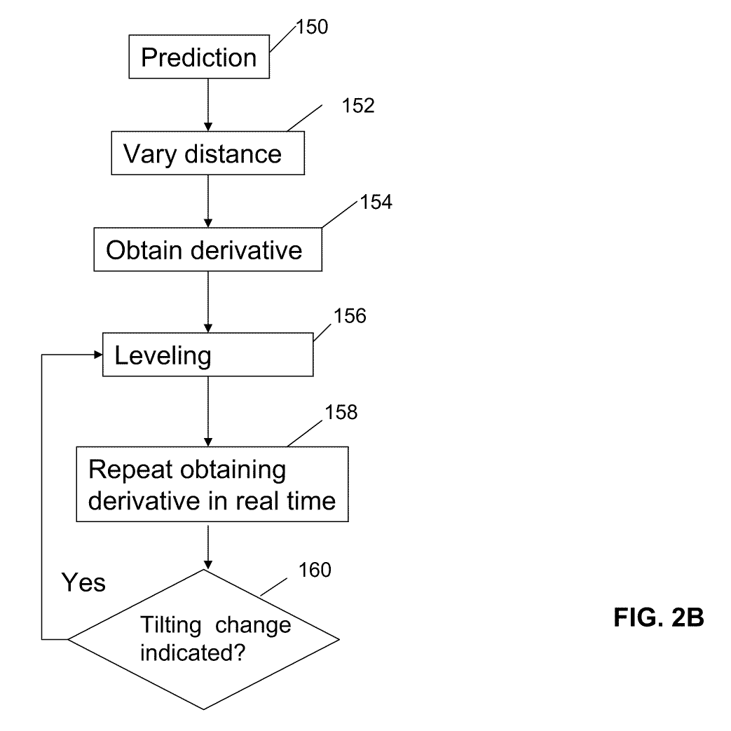

An automatic leveling method is illustrated in the flow chart in FIG. 2A. In step 120, the process is started. The starting procedure can be simply a push of a button, and little or no human intervention is needed afterwards. Or semi-automated processes can be used.

As described in the references cited above, a variety of improvements implemented by NanoInk on both the device (article) and software (methods) have addressed some of the issues in the conventional methods and systems. For example, view ports allow operators to see the cantilevers, and the operators can level the array by inspecting the deflection characteristics of the tips.

Viewports in the silicon handle wafer allows the operators to level the array by inspecting cantilever deflection characteristics at 3 different points. Instead of using epoxy, magnetic force can be employed to hold the components together. For example, a wedge having magnets therein can be used.

Viewport leveling is substantially faster than conventional methods and can be completed, for example, in a matter of minutes, making mounting the device very straightforward via the magnetic wedge, thereby preventing the cross-contamination. Versatility for a variety of different samples includes: different samples of different thicknesses with the same array, moving large distances in x-y directions and correcting for changes in z-displacement, moving across larger samples (that is not necessarily perfectly flat) and maintaining “level,” while the viewports allows the operators to spot check and correct errors. The need for gold can be eliminated by engineering stressed nitride layers on the cantilevers to achieve sufficient freedom of travel for the tips. Because not all chemistries are amenable to gold coated tips, and gold-coated tips quench fluorescence for imaging multiplexed ink on the array, gold-free tips improve the versatility of the system. Further, the fact that the silicon handle chip is not transparent (or even translucent) is desirable because it prevents ambient light from bleaching bio inks. The viewports also provide a way to get a clear laser signal onto a cantilever for imaging and force feedback.

However, human interaction with robust nanomanufacturing solutions based on visual cues still has undesirable aspects. These included, for example, difficult initial “coarse leveling.” This is usually performed subjectively, by eye. If the array is too far out of level initially to enable the middle-of-the-array cantilevers to be touching (because the corners come into contact with the surface first), it becomes very difficult to go through the manual optical-deflection-monitoring algorithm. The system can require significant human interactions in order to achieve leveling. The need for observing optical deflection imposes design constraints on the MEMS, the mechanical hardware, the optics, and the software. More recently-developed passive self-leveling gimbal addresses some, but not all, of the above issues. See, e.g., U.S. Provisional Application Ser. No. 61/226,579, “Leveling Devices and Methods,” filed Jul. 17, 2009, the disclosure of which is hereby incorporated by reference in its entirety. In accordance with some embodiments, a view port is not needed.

These techniques can be incorporated in step 122, a pre-leveling process. Other coarse leveling methods known in the art can also be used. In step 124, a distance between the two objects, e.g., the distance between a first plane defined by the tips of the array of pens and a second plane defined by a substrate surface, can be varied using an actuator. In step 126, a force is measured. The force can be a force applied to one or both of the two objects, or a feedback force measured by a force sensor. In step 128, derivatives of the force to the distance or time are calculated. In step 130, a tilting is varied, e.g., using an actuator. The tilting can be varied in one or both x, y directions. In step 132, a controller such as a computer determines whether the force derivative is increasing. If so, in step 134 the tilting is varied in the same direction to find the peak of the force derivative, and the measurements are iterated in step 136. If the derivative is decreasing, in step 135 the tiling is varied in an opposite direction in an attempt to find the peak value.

In step 138, the controller determines whether the force derivative has discontinuity associated with a peak value. If so, in step 140 the false peak is rejected. In step 142 the two objects are leveled, or a tilting therebetween is measured, based on the peak value in the force derivative.

The derivative method in accordance embodiments disclosed herein allow simultaneous quantitative knowledge of planarity and force. As adapted for automation, it provides real-time, in situ information regarding force-feedback and planarity-feedback. As such, this enables the unprecedented ability to pattern on non-flat surfaces, since the planar-feedback mechanism can adapt in-process to re-level the system. This could include multiple substrates at different planarities, substrates with significant bow or debris, or even spherical surfaces.

An exemplary automatic, adaptive leveling method is illustrated in the flowchart of FIG. 2B. In step 150, a prediction can be made regarding the force-distance, distance-distance, force-time, or distance-time relation shape, as described in detail below. In step 152, a distance is varied based on the prediction. In step 154, a derivative is obtained. In step 156, leveling is obtained between two objects, for example, using iterative methods illustrated in FIG. 2A. The tilting and/or distance between the two objects can change over time. Thus, in step 158, the steps of 152 and 154 are repeated so that the derivative can be obtained in real time. In step 160, it is determined based on the in situ derivative calculation/measurement whether the tilting has changed. If so, the leveling step 156 is repeated to obtain a new, real time leveling.

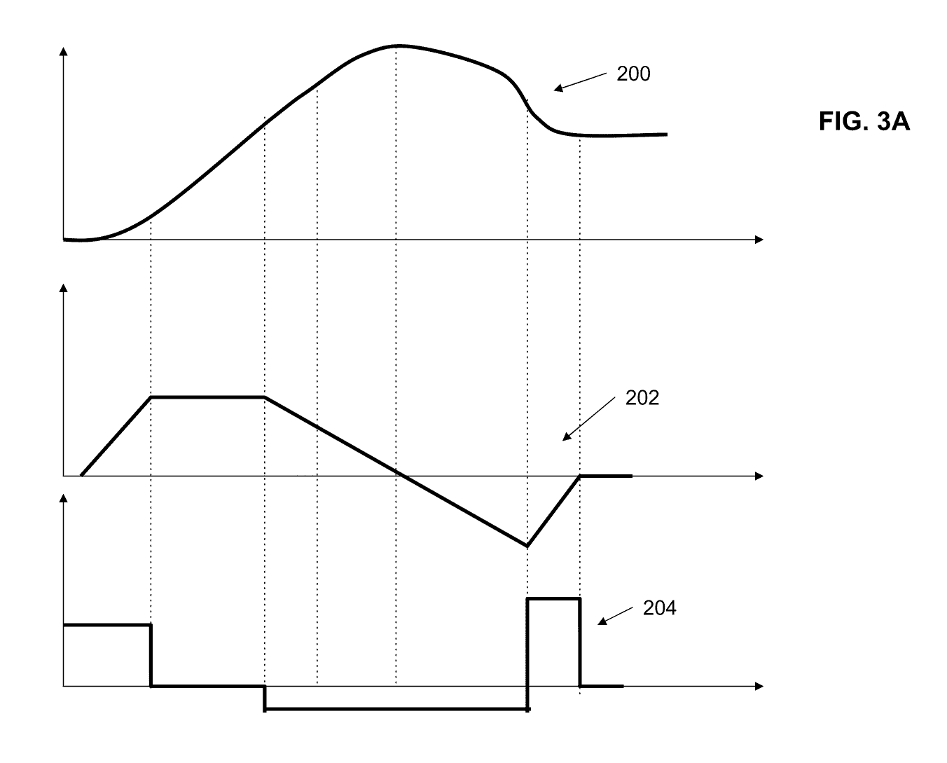

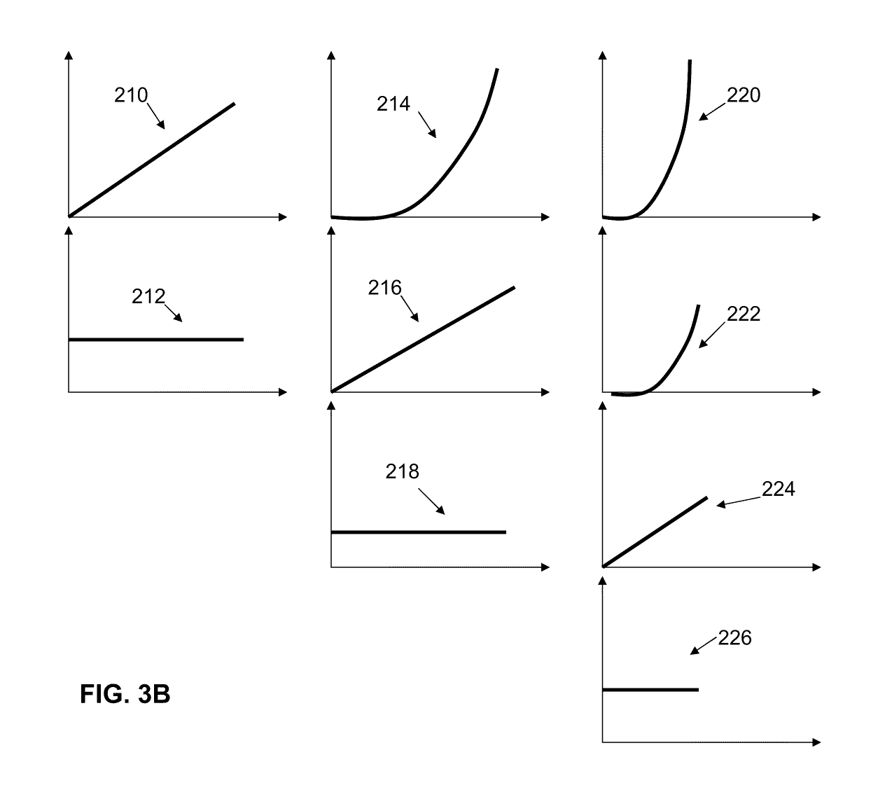

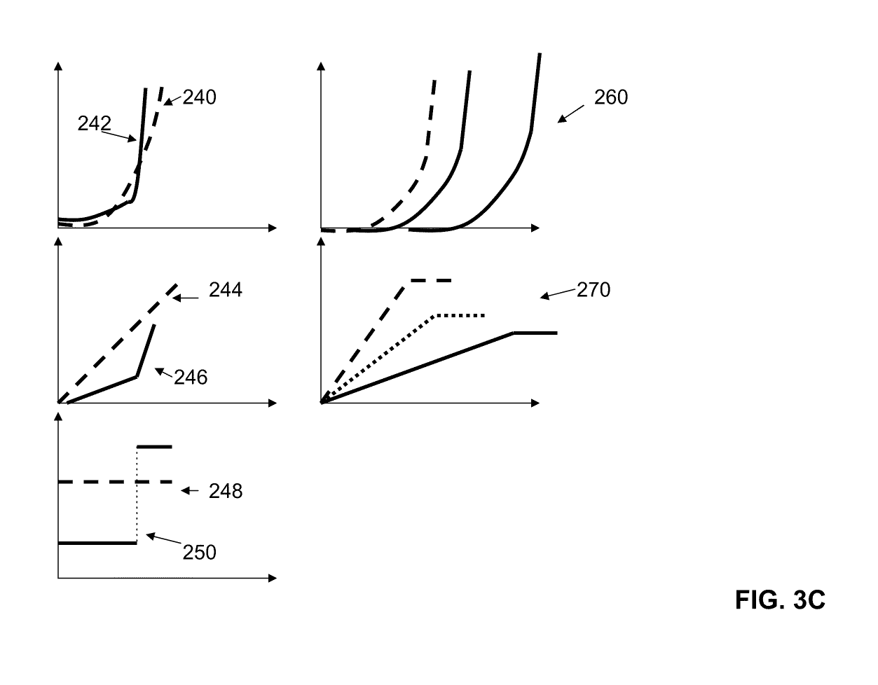

The richness of the information obtained from the derivative method in accordance with the embodiments disclosed herein can be illustrated in FIG. 3A. For example, a curve 200 itself representing a force-distance relationship, a distance-distance relationship, a force-time relationship, or a distance-time relationship show some information about the two objects. However, the information in the first order derivative shown in the curve 202 and the second order derivative shown in the curve 204 cannot be immediately visualized from the curve 200.

The relationships between various force curves and their derivatives are sketched in FIGS. 3B and 3C. For example, as shown in FIG. 3B, the linear relationship 210 (F=kz) has a derivative 212 that is a constant k. The curve 214 (F=Cz²) has a first order derivative 216 that is linear, and a second order derivative 218 that is a constant. The curve 220 (F=Cz³) has a first order derivative 222 in the form of 3Cz², a second order derivative 224 that is linear, and a third order derivative 226 that is a constant.

In FIG. 3C, both curves 240 and 242 are shown to be continuous. The first order derivative 244 of the curve 240, and the first order derivative 246 of the curve 242 show more clearly the difference. The second order derivatives 248, 250 further more clearly show a discontinuity in the curve 250, indicating that, for example, the substrate surface comes into contact with the edge of the chip, which is substantially rigid, rather than contacting the tips.

The three different curves 260 show that the two objects come into contact at different distances. If only a two-point measurement of force is made, the force difference would be the same after all tips touch the substrate surface and the curves behave linearly. However, the derivatives 270 provide more information about the array behaviors and how to level the tips with respect to the substrate surface.

### Force Sensor

A variety of force sensors can be used for the measurements of the feedback force or to obtain the derivative of force. The force sensor can measure the force in the range, for example, of 1 pN to 1 N.

The force sensor(s) can be the Z-piezo and/or capacitive and/or inductive sensors of an existing AFM instrument. The system can be operated in “open-loop” mode and the Z-actuator can both move the device and make force measurements.

In some embodiments, the force sensors can include a multi-stage sensor suitable for force measurements in different ranges or at different levels of accuracy. For example, a first, precision stage can include a precision beam balance and a sensitive spring or flexure. A second stage can include a spring or flexure having a higher force capacity.

The force sensor in the apparatus preferably has a low signal-to-noise ratio, and specifically, a low noise floor while floating in free air. For example, the noise floor of the force sensor may be 0.25 mg or less. The force sensor preferably has a load limit that balances the need for range and resolution. For example, the force sensor may have load limit between 10 g and 30 g. Preferably, the planarity of the force sensor does not change dramatically when the force sensor is loaded and thus deflects in the vertical direction. The force sensor may have, for example, a parallelogram design that prevents a dramatic change in planarity. The force sensor may be, for example, a load cell, such as those manufactured by Strain Measurement Devices.

### Force Derivative Methods (FDM)

Embodiments disclosed herein help to reduce or entirely remove human interaction for leveling operations, and thereby can make the process semi- or fully automated. An automated machine/robot process can include, placing a substrate on a sample stage using a robotic arm, automatically attaching a printing array to the instrument, using software to detect the presence of both the substrate and the printing array, and to initiate leveling sequence. The leveling sequence can employ software to initiate patterning. With the patterning concluded, a robot can be used to remove both the printing array and the substrate.

FDM achieves the additional goal of not requiring any optical feedback, and thereby removing the design constraints that previously require a clear optical path between tips and a microscope. Achieving planarity can employ FDM, not just between a 2D DPN array and a substrate, but between any two objects where either one is compressible or flexible.

Although it may be possible to perform leveling only using two endpoint measurements of force, without calculating the derivatives or the rate of changes of the force, the two-point method may not result in satisfactory results at least in some cases. For example, in the situation illustrated in the upper right panel of FIG. 3C, the two-point measurements would provide the misleading impression that level is achieved. This is because in the second portions of the three curves, the slopes are the same. This misses the fact that the slopes vary elsewhere in these curves. Thus, the two-point measurements can be misleading or incomplete. FDM can account for this by giving a spectrum of information of the complicated compression characteristics of any materials.

Without measuring or calculating dⁿF/dzⁿ, the two-point measurements also rely on iterative process of measuring two-points across many ranges of stage angles. By contrast, FDM can be automated to happen in a short time scale, such as milliseconds. FDM can achieve a better precision than conventional methods, for example, with >>0.1 mN precision, and subsequently a reduced planarity measurement limit, for example, with measurable tilting of <0.004°.

Furthermore, it is noted that FDM advantageously does not need absolute reliable force measurements, as long as changes in the force are measured consistently. For example, the force sensor(s) does not necessarily need to be calibrated to known loads. This provides some flexibility in accounting for environmental noise, thermal drift, etc. For example, the measured force Fₘ could be the true value of the force Fₜ times a constant C, the derivative dFₘⁿ/dz=CdFₜⁿ/dz would still have a maximum at the same relative position of the two objects as dFₜⁿ/dz.

### Compressible Elements

FDM can be used to level two substantially planar objects, where either one or both of the objects comprise a compressible material, a compressible element, or a flexible material/element.

For example, the array can include a backing and an array of tips disposed over the backing, and at least one of the backing, the tips, or the second object can be compressible. Alternatively, an array of cantilevers having tips thereon can be disposed over the backing, and the cantilevers can be flexible.

### Rigid Mechanical Loop

The “mechanical loop” can be defined as the smallest point-to-point distance between the first object and the second object, such as the array to the substrate surface. When the array and substrate are not in contact, the shortest path between them forms a “C” shape. When they come into contact, they form an “O” shape. This mechanical loop is preferably made as rigid as possible. This can be achieved, for example, by making all except one components as rigid as possible. For example, if the tips are compressible, the backing and the substrate are made as rigid as possible, thereby more accurate measurements can be made without convoluting compressions from several components of the system.

A rigid mechanical loop can be included in the leveling system, with kinematically mounted non-moving components. A rigid mount can be included in the rigid mechanical loop. For example, the array and the substrate can both be rigidly mounted. For example, the substrate can be glued down to a glass slide, and the array can be fixed with magnets. Thus, only the tips or cantilevers compress/flex.

Without rigidly mounting an array, for example, with 3 points of rigid contact, it is possible that the device may rock back and forth, introducing additional coupled-Z motion complexity in addition to the scale's motion.

On the nanolithography platform (NLP) system by NanoInk (see, for example, US Patent Publication No. 2009/0023607, filed May 7, 2008), this can include the mounting arm, the ceramic fixture, the stage frame, the instrument base, the X, Y, Z, Tₓ, T_{y} stage stack, and the substrate plate. In accordance with embodiments disclosed herein, the force sensor(s) can be either immediately above the array or immediately below the substrate, or anywhere in the mechanical loop.

In one embodiment, a rigid, gravity-friendly, removable kinematic mount is provided. A modification of the existing self-leveling gimbal fixture arm can be made to enable rigid mounting of a 2D array. Three magnets can be glued to the back of an array handle. The three magnets later can adhere to the underside of a rigid rectangular frame of magnetically permeable material. This aims to ensure that all monitored motion and forces are restricted to the elements of interest, and that there are no tangential system components flexing and bending to obscure the data.

### EXAMPLES

There are several ways to begin implementing the FDM to achieve planarity between two objects. The system can include an accurate and precise force sensor(s), and an accurate and precise actuator. The actuator can be, for example, a Z-stage.

In one embodiment, FDM is performed by monitoring force readings while actuating the actuator to drive the array or the substrate. For example, the load is continuously measured, or measured at each actuating step, while the Z-stage is actuated upward toward the 2D array. In an automation process, FDM can be performed by real-time monitoring of force readings (with a high sampling rate for data acquisition) as the Z-stage moves the substrate into contact with an array.

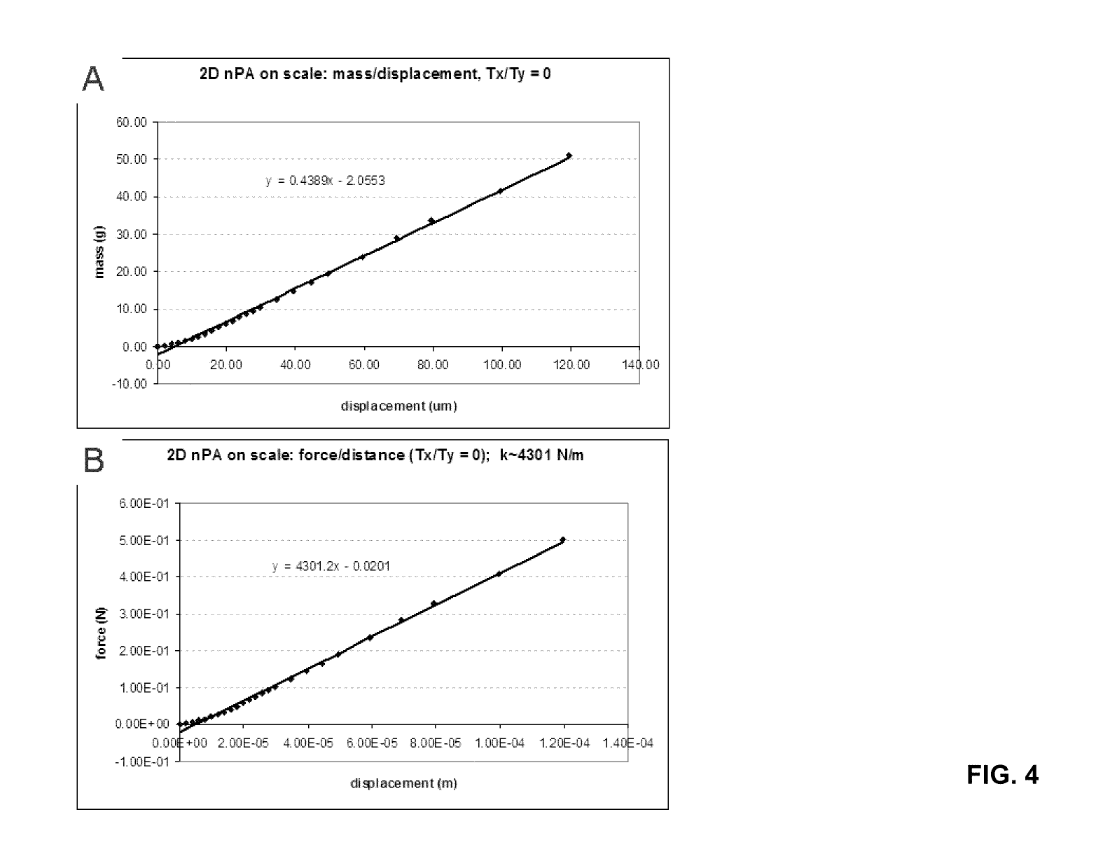

FIGS. 4A and 4B show force-distance curves for the 2D nPA interacting with the substrate at its initial planarity (no Tₓ, T_{y} adjustments). To obtain the data in FIG. 4A, an epoxy “pre-leveled” array is brought into contact with the surface. Displacement of 0 μm indicates the point at which the scale started reading a load measurement. The stage is then continued to be actuated to compress the cantilevers by the amount shown. Since the cantilevers have only 15 μm freedom of travel, while actuation can be achieved, for example, 120 μm, it is clear that the scale begins giving way (e.g., started compressing) at some point, and the initially dual-spring system goes back to a single-spring system.

FIG. 4B illustrates similar data, but mass is converted to force, and displacement is converted from μm to m. As shown in FIGS. 4A and 4B, the collective k of an array is influenced strongly by the scale. The value of k can be somewhat higher than the scale.

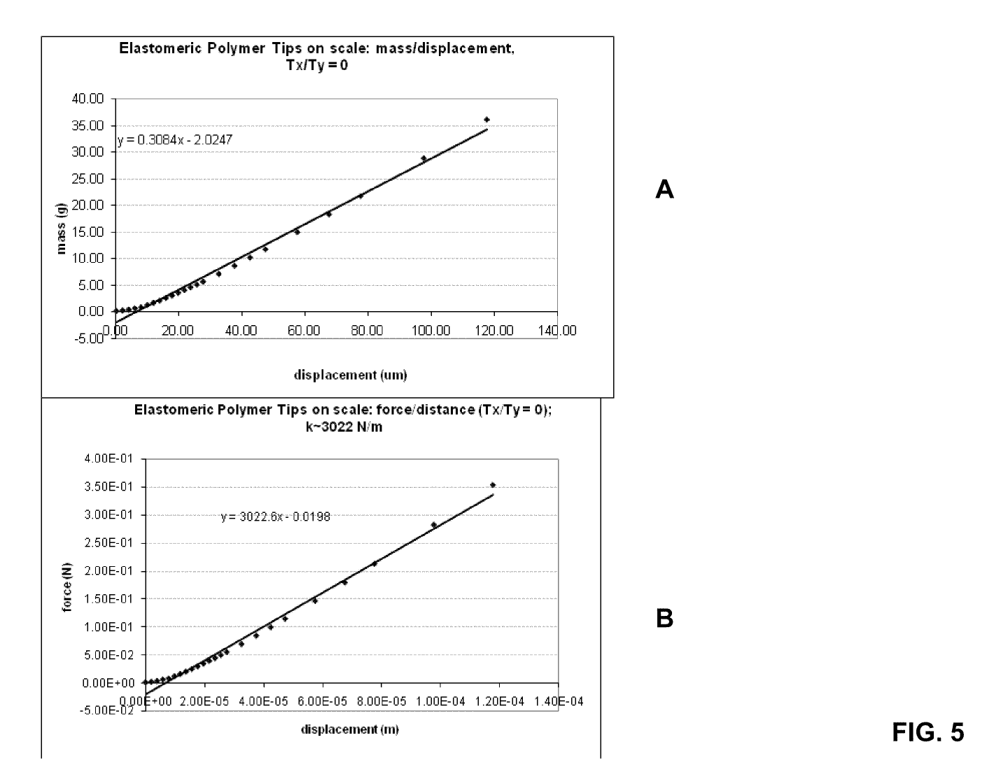

FIGS. 5A and 5B illustrates similar measurement for an EPT array (fabricated on a transparent glass backing-substrate). As shown, the collective k of this array is also influenced strongly by the scale. The k value of the array is slightly higher than the scale. For example, ˜k_{2D nPA}=4301 N/m, ˜kₑₗₐₛₜₒₘₑᵣ=3022 N/m. The elastomeric tips can be slightly more compressible than the cantilevers.

According to the equations supplied below and the measurements obtained in FIGS. 4A-5B, various spring constants k can be obtained:

$${k}_{2 DnPA} = \frac{{k}_{scale } \cdot {k}_{collective}}{{k}_{scale} - {k}_{collective}} = \frac{6000 \cdot 4301}{6000 - 4301} = 15 \text{,} 188 ( \frac{N}{m} ) , and$$

$${k}_{EPT} = \frac{{k}_{scale} \cdot {k}_{collective}}{{k}_{scale} - {k}_{collective}} = \frac{6000 \cdot 3022}{6000 - 3022} = 6088 ( \frac{N}{m} )$$

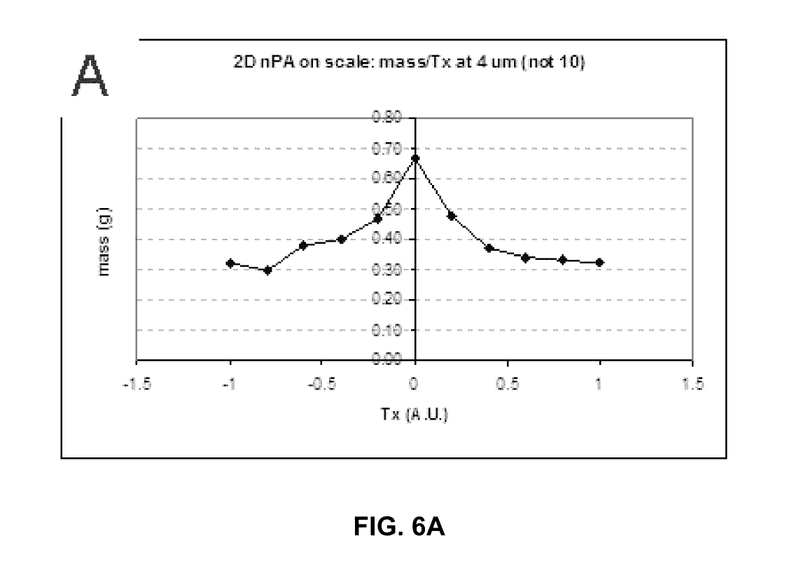

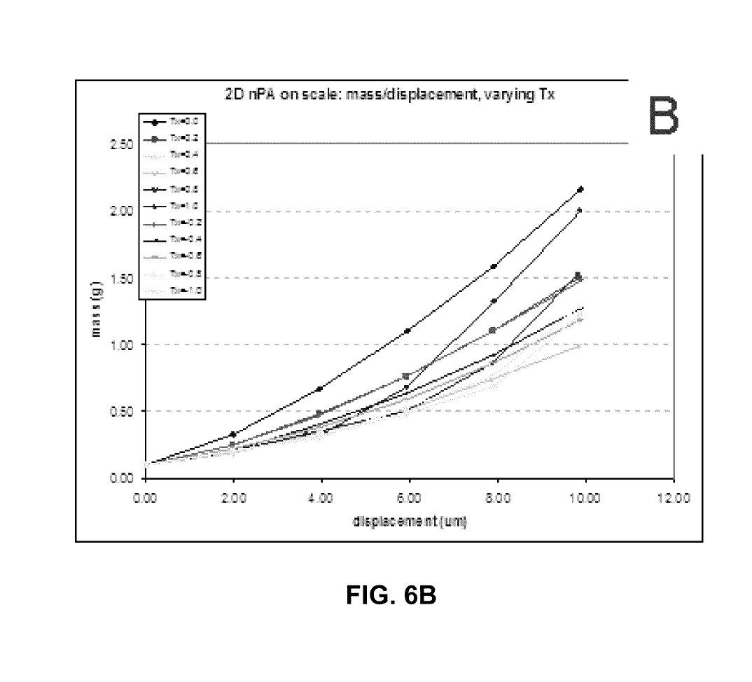

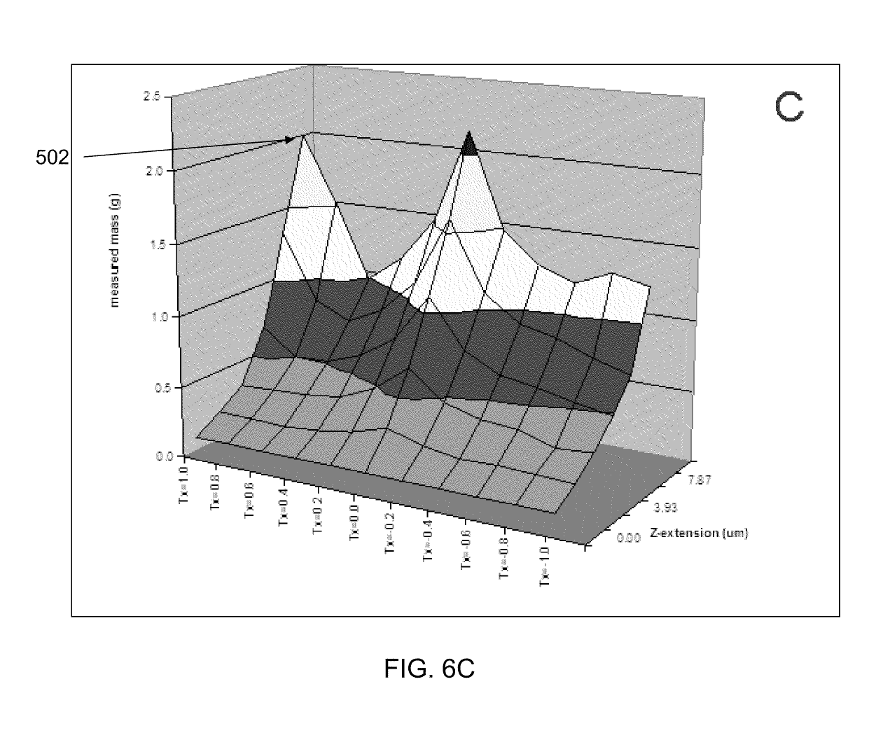

FIGS. 6A-6C show force curves for the 2D nPA collected at various Tₓ positions. Specifically, FIG. 6B shows the comprehensive data set of the force distance curves at a variety of Tₓ tilt positions, and with limited actuation (0-10 μm only). FIG. 6C shows this same data set plotted in 3D. FIG. 6A shows the cross-section of FIG. 6C at a Z-extension of 4 μm. From this data set, it can be seen that the dF/dz slope is steepest at Tₓ=0, where the array is the most level.

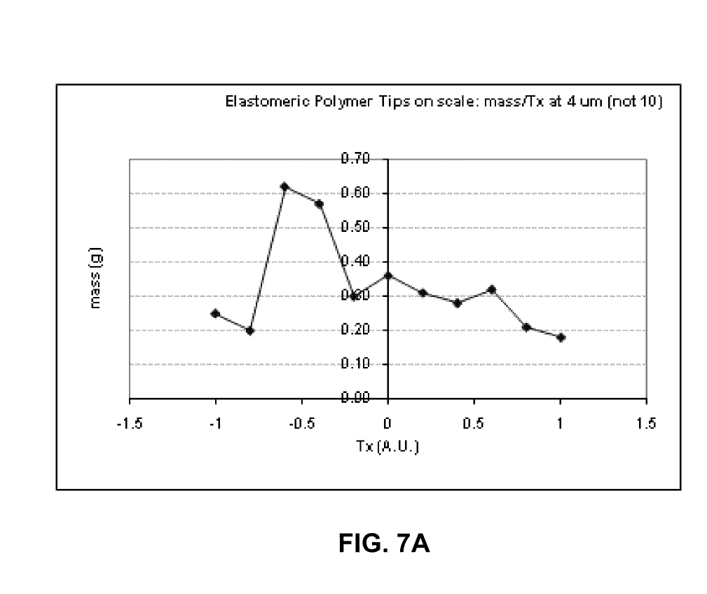

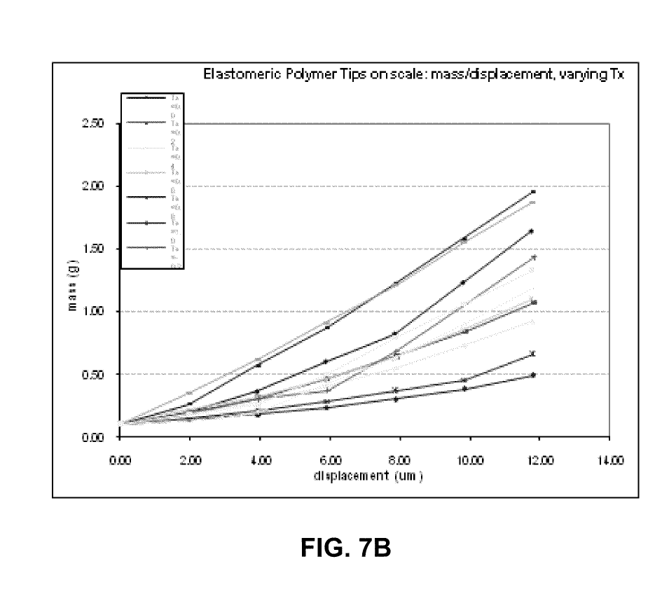

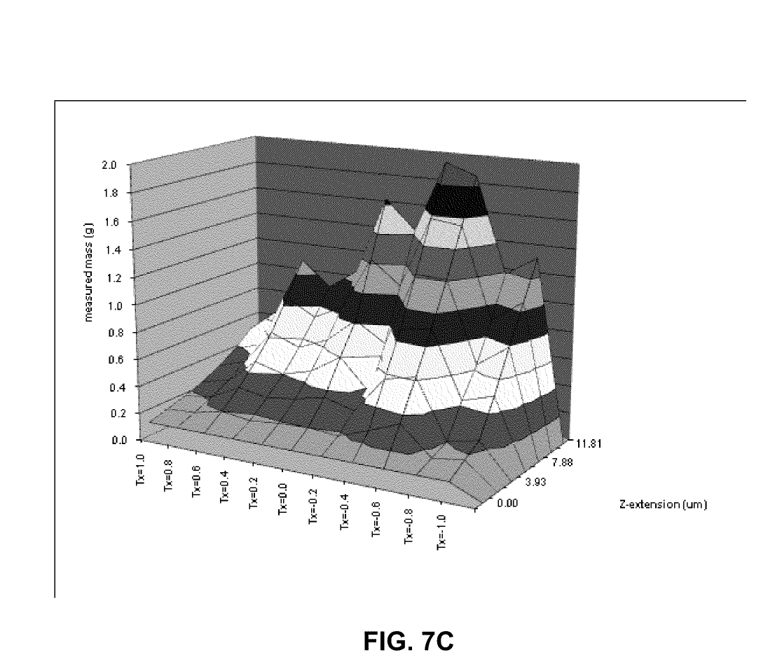

FIGS. 7A-7C show force curves for the EPT array collected at various Tₓ positions. Specifically, FIG. 7B shows the comprehensive data set, FIG. 7C shows this same data set plotted in 3D, and FIG. 7A shows the cross-section of FIG. 7C at a Z-extension of 4 μm. There is a dF/dz maximum at −0.6<Tₓ<−0.4. This suggests that the array shifted slightly after initial pre-leveling with epoxying, which as discussed above has known errors. Indeed, this mechanical fixturing is considered preliminary, non-robust, and the epoxy technique is prone to volume distortion. Embodiments disclosed herein help overcome these drawbacks.

Thus, the generalized FDM method works for the two different arrays of different design and materials shown in FIGS. 6A-7C.

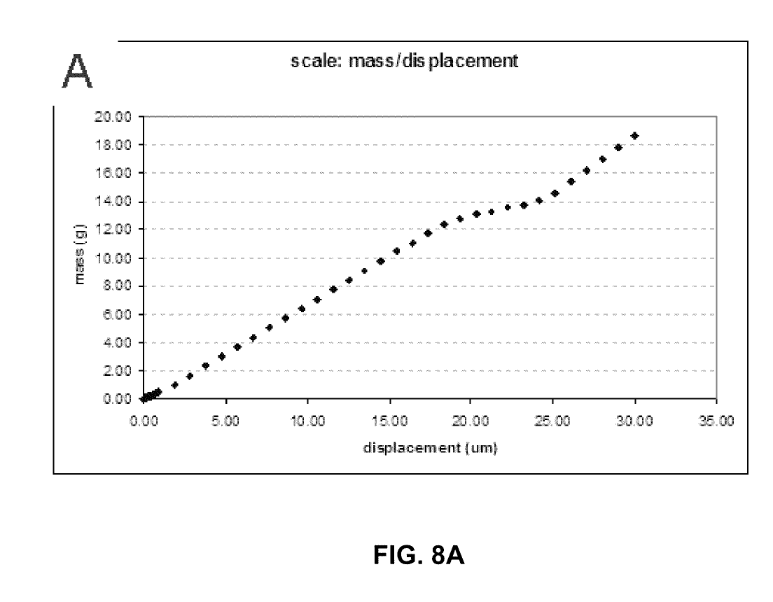

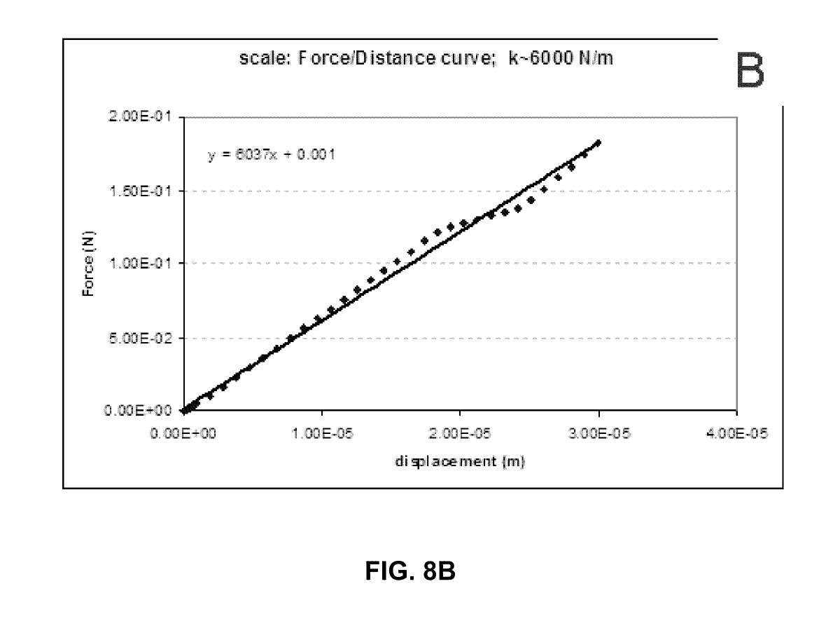

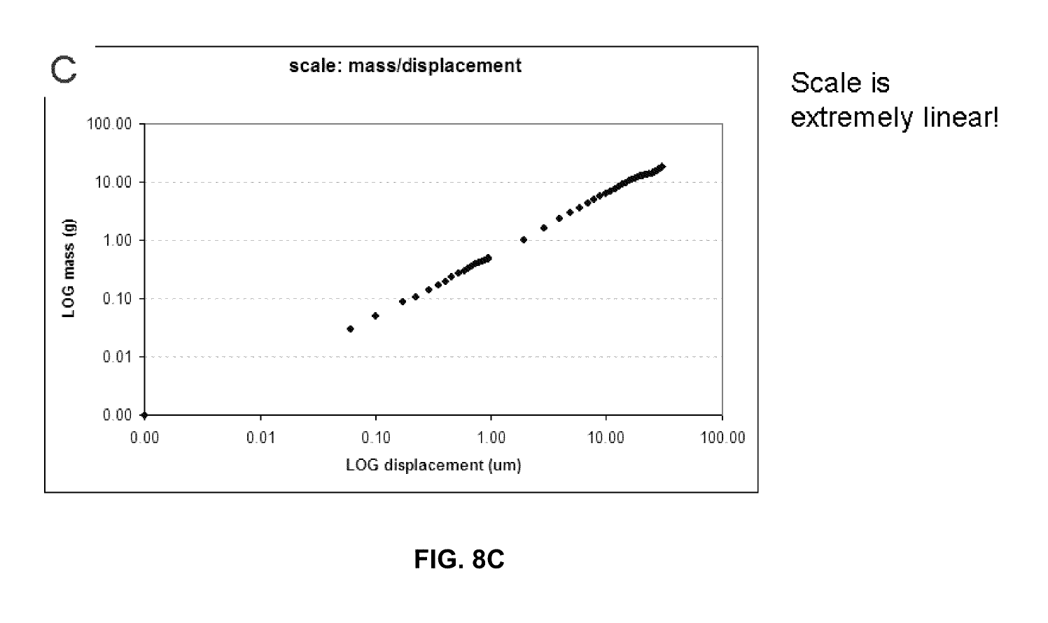

FIGS. 8A-8C illustrate the force-distance curve measurements of the OHaus scale alone against the rigid probe mount arm. This verifies that the scale itself behaved in a linear way, and therefore would not compromise any subsequent system measurements.

Various algorithms can be employed for the automation process. First, the relative distance between the array and the surface is varied, for example by a step motor. This step is referred to as the “Z-extension.” Next, the force profile is recorded as a function of the distance Z. A derivative is calculated from the force profile. The tilting in the x and y directions, Tₓ and T_{y}, respectively, are adjusted until a position is found to have the maximum force. In one embodiment, if the force derivative profile decreases, the program will instruct the system to move to an opposite direction in Tₓ or T_{y}, thereby finding the maximum value faster.

Instead of evaluating the force derivative of the distance Z, the force derivative of time can be evaluated while moving z, φₓ, and φ_{y} at constant rates.

Finite Element Analysis (FEA) predictive method can be employed in accordance with embodiments disclosed herein. When material characteristics are known beforehand, the system can anticipate what a given force-distance curve should look like for a given orientation. For example, the derivation above reveals k_{2DnpA}=15,188. If the system were to take a force-distance curve of an identical device where k=10,000, one would know that the device is out-of-level. If this were performed at two different known φₓ and φ_{y} orientations, the system could then calculate and predict where φₗₑᵥₑₗ would be. It could go there in one step.

In some embodiments, pre-characterized devices can be employed. Different arrays (2D nPA, EPT, etc.) can be pre-characterized at the factory so that customers receive a device with a “known” k=a+/−b. This k value is then entered into software and used in a predictive method. An array arrives with known k, and subsequent FDM readings inform how it should be leveled more quickly and efficiently.

Any of these algorithms allow the user to monitor and compensate both the applied force and the planarity on-the-fly for any objects when they are in contact. These objects can be made of any materials. For nanopatterning, this provides not only force-feedback but also planarity-feedback. For the case of writing dot arrays, each written dot provides its own force-distance curve which can be monitored, compared to the one preceding, and Z, X, Y, φₓ, and/or φ_{y} corrections can be applied before the next dot.

The speed of the system may be limited by the data acquisition rate and precision of the force sensor(s), and the actuation speed and acceleration profile of the actuator (Z-stage).

Moreover, the FDM method provides automation means to correct for “non-ideal boundary conditions.” One example is seen in FIG. 6C. As the device gets progressively more and more out of level, the corner of the 2D array starts hitting the substrate. This corner can be part of the silicon handle wafer, and can be much more rigid than the SiN cantilevers. Thus, there is an anomalous force spike 502. However, this can be accounted for according to the method described in FIG. 3C. When taking the derivative of the force curve—even a non-linear one—the resulting motion should still be continuous. A discontinuity can imply an obstruction, which would prompt the system to go back and try a different φ_{x,y} orientation. Some thing moving nonlinearly . . . higher order derivative will manifest discontinuity in FIG. 3C.

The FDM method can be used even in the case of arbitrarily small z-extensions. With sufficient precision, z-extensions can be only several hundred nanometers (or smaller), and a difference in dF/dz slope versus planar orientation can be revealed. This is desirable for minimizing pre-patterning surface contact time with inked tips. This is also desirable for minimizing the “obstruction encounters” described above. Note that the obstruction revealed by the peak 502 in FIG. 6C does not occur until ˜z=6 μm. The sensitivity of the system employing the FDM can be very useful if arrays constructed out of very delicate materials are used, such as materials that have a low upper-bound to their force tolerance. Small Z-extensions would enable a “feather touch” type leveling scenario.

In one example, a modified mount on the NLP is employed to rigidly mount a 2D array. The actuator can be the NLP Z-stage. The X and Y stages can be used to pre-position the scale under the array. Tₓ and T_{y} are varied according to the data in FIGS. 6A-7B in order to illustrate the different dF/dz behavior at different planarities.

A pocket scale (e.g., Ohaus YA102, 0.01 g precision) can be mounted on the NLP stage plate as the force sensor. Measurements can be made with a known “nearly level” device, as achieved using an epoxy procedure. For example, the array can be left on the substrate, and then brought up to magnets on the mounting arm that are pre-loaded with epoxy. After a few minutes' wait time (e.g., the curing time of the epoxy), the stage can be retracted, and the near level surface is obtained. Other errors can result, for example, from that the epoxy can go through volume distortion. Embodiments disclosed herein can achieve leveling without the epoxy procedure.

All instrument motions can be coordinated via the NLP software. Force readings can be taken directly from the digital display of the Ohaus scale. The scale can be pre-calibrated according to factory procedure via a known 100 g mass.

The Ohaus pocket scale can be pre-characterized according to the plot in FIGS. 8A-8C. In conjunction with FIGS. 4A-5B, FIGS. 8A-8C show that the spring constant of the scale itself (k_{scale}˜6 k N/m) is within an order of magnitude of the collective spring constants of both a 2D nPA and an EPT array. The collective spring constants shown in FIGS. 3B and 4B are related to the scale by Hooke's law for springs in series as:

$${k}_{collective} = \frac{1}{\frac{1}{{k}_{scale}} + \frac{1}{{k}_{array}}} = \frac{{k}_{scale} \cdot {k}_{array}}{{k}_{scale} + {k}_{array}} \\ ⇒ F ( z ) = - {k}_{collective} \cdot z = - ( \frac{{k}_{scale} \cdot {k}_{array}}{{k}_{scale} + {k}_{array }} ) \cdot z$$

One result of this relationship is, unlike methods relying on optical measurements of cantilever deflection, that the movement of any given part of the system (cantilever, tip, etc.) cannot be assumed to move the same amount as the Z-stage actuation.

In some embodiments, a tripod configuration is used for the measurement of force, where the force is measured from, for example, three different points arranged geometrically symmetric about the center of the patterning array. The differential between the three sensors creates a vector that describes the device planarity. The device is level when there is no vector and the force is balanced at all three sensors.

The configurations of the system can be carefully monitored/controlled for temperature, relative humidity, vibration, etc., to mitigate spurious readings and/or drift due to environmental changes. For example, environmental enclosures can be used to keep the system at a constant, higher-than-ambient, temperature, and other approaches.

### Intermediary Objects

In some embodiments, the array does not touch down on the substrate surface, but touches down on an intermediary object which matches the substrate planarity. This approach prevents unwanted inking of the substrate. The intermediary object can be a flat slab device. The intermediary object can be employed in embodiments without the force derivative methods.

The intermediary object can also be composed of, for example, three balls discussed above in the tripod configuration. The three balls can be placed under three corners of the device providing three different points of contact. The force derivative curves are measured independently as each corner touches each ball. The device is considered planar when the maximized force derivatives curves are equal.

The three balls can be part of a rigid, connected frame. Alternatively, only one ball can be employed. The single ball can be “picked-and-placed” by a robotic arm. The intermediary balls/objects can be pre-fabricated at specific positions on the substrate. These intermediary objects can be coarsely pre-leveled according to a passive self-leveling gimbal device as described in the cited references. Thus, in a leveling system, both the balls and a passive self-leveling gimbal device can be employed.

In some embodiments, the balls are not on the substrate but are actually incorporated into the array itself for use with a self-leveling gimbal (see, e.g., A sufficient force can flex the balls back into the soft backing material allowing the tips to touch the substrate surface.

Patterning with Large Pen Numbers and Large Size Pen Arrays Over Large Areas with Improved Results and Efficiency

In one embodiment, the array of tips is characterized by an area of tips on the array which is at least one square millimeter. In one embodiment, the array of tips is characterized by an area of tips on the array which is at least one square centimeter.

In one embodiment, the array of tips is characterized by an area of tips on the array which is at least 75 square centimeters.

In one embodiment, a fraction of the tips transfer ink to the substrate, and the fraction is at least 75%. In one embodiment, a fraction of the tips transfer ink to the substrate, and the fraction is at least 80%. In one embodiment, a fraction of the tips transfer ink to the substrate, and the fraction is at least 90%.

In one embodiment, the array of pens comprises at least 10,000 pens. In one embodiment, the array of pens comprises at least 55,000 pens. In one embodiment, the array of pens comprises at least 100,000 pens. In one embodiment, the array comprises at least 1,000,000 pens.

In one embodiment, the array of pens is characterized by an area of pens on the array which is at least one square millimeter. In one embodiment, the array of pens is characterized by an area of pens on the array which is at least one square centimeter. In one embodiment, the array of pens is characterized by an area of pens on the array which is at least 75 square centimeters.

In one embodiment, a fraction of the pens transfer an ink to the substrate, and the fraction is at least 75%. In one embodiment, a fraction of the pens transfer an ink to the substrate, and the fraction is at least 80%. In one embodiment, a fraction of the pens transfer an ink to the substrate, and the fraction is at least 90%. The leveling methods and instruments described herein can increase the fraction of pens which transfer ink to substrate.

### Force Curve Analysis Generally

The present invention is not limited to an approach for leveling based on obtaining a derivative of a force curve. Rather, the approach for leveling may be based on obtaining a force curve parameter generally, where the force curve parameter may be a derivative or some other parameter of the force curve. Thus, the method and devices discussed prior with respect to obtaining a derivative of a force curve apply to the approach based on obtaining a force curve parameter generally.

In a similar fashion to the approach based on obtaining a derivative, for the approach based on obtaining a force curve parameter generally, the distance can be also expressed as a function of time. Alternatively, the force curve parameter can be obtained for a first distance and a second distance, wherein the first and second distances include, for example, an actuation distance or a response distance, as described above. The curve parameter of the curves of the first and second distances is related to the force curve parameter, and thus can be used for leveling as well.

### Integral as Force Curve Parameter

As an alternative to calculating a derivative as a force curve parameter of a force curve, an integral of the force curve may instead be calculated. If the probes and the surface are relatively level with each other, as the distance between them decreases, the integral of the force curve will be greater as compared with the case where there is a larger tilting between the probes and the surface. Thus, a large integral is an indication that the probes and the surface are level relative to each other.

Further examples of a force curve parameter or obtaining a force curve parameter of a force curve may include moving averages, regression analysis, polynomial fitting, and moving slope analysis.

### Automation Using Force Curve Parameter

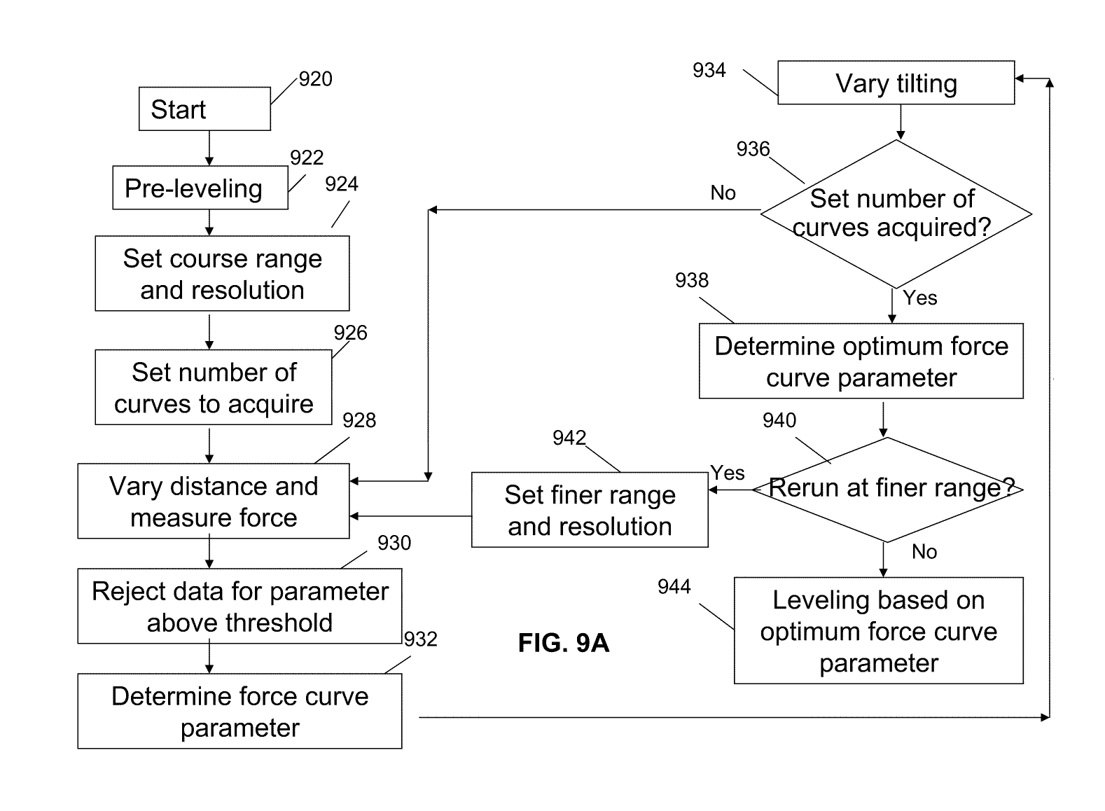

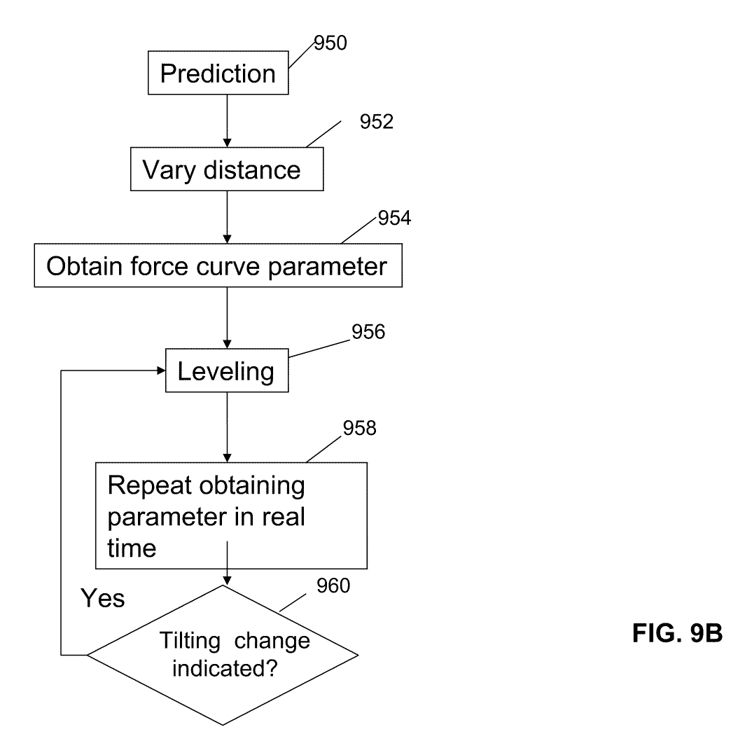

Automation of leveling using a force curve parameter generally is analogous to that using a force derivative where the force curve parameter generally is substituted for a force derivative. In this regard, automation using a force curve parameter generally is described with respect to FIGS. 9A and 9B, which are similar to FIGS. 2A and 2B, respectively, where the derivative is replaced with a force curve parameter generally.

As shown in FIG. 9A, the process starts in step 920 and a pre-leveling process is performed in step 922 in a similar fashion to step 122 in FIG. 2A. A coarse range and resolution for a sweep of the tilt parameter may be set in step 924. Based on the range and resolution, the number of force curves to be acquired in the coarse sweep can be determined in step 926. For example, the number of force curves to be acquired may be the range divided by the resolution plus 1. In step 928, a distance between the two objects, e.g., the distance between a first plane defined by the tips of the array of pens and a second plane defined by a substrate surface, can be varied using an actuator. The distance may be varied in a continuous or a stepwise manner, for example. Further, in step 928, the force may measured simultaneously with varying the distance. The force can be a force applied to one or both of the two objects, or a feedback force measured by a force sensor. In step 928 the force curve is incremented according to the current force and distance. The force curve is built up by incrementing the force and distance for a particular tilt parameter. The force curve may be incremented in a continuous or a stepwise manner, for example. In step 930, the controller determines whether the force curve parameter is beyond a threshold value. If so, the force curve parameter for the current tilt parameter is rejected, and the force curve parameter may be truncated for the current tilt parameter.

In step 932 a force curve parameter of the curve of the force over the distance or time is calculated. The force curve parameter may be a derivative or an integral of the force curve, for example. In the case of determining an integral as the force curve parameter, the integral should be determined over a same displacement range for each tilt parameter so that the integrals may be meaningfully compared in step 938. If the integral is not determined over a same displacement range, a larger integral may erroneously be found for a longer displacement range. The displacement for determining the integral for a particular tilt parameter starts from the point where the scale starts to read a load measurement, which is the zero displacement point for that tilt parameter.

In step 934, a tilting is varied, e.g., using an actuator. The tilt parameter is incremented according to the resolution of the tilt sweep. In step 936, it is determined whether or not the number of force curves to be acquired for the current tilt parameter have been reached. If not, the process proceeds to step 928, where the distance is varied and the force measured. If yes, flow process to step 938, where the optimum force curve parameter is determined. For example, if the force curve parameter is an integral, the optimum force curve parameter may be the largest integral. In comparing integrals, the integrals should be determined over a same displacement range from the zero displacement point for each tilt parameter, as noted above with respect to step 932.

In step 940 it is determined whether a tilt sweep should be rerun at finer resolution and over a shorter range of tilt parameter values. For example, the tilt sweep may be always rerun at a finer resolution and shorter range if a coarse sweep has just been run. If finer sweep is to be run, in step 942 a shorter range is set where the tilt parameter corresponding to the optimum force curve parameter (such as largest integral) is near the middle of the shorter range. If no finer sweep is to be run, the process proceeds to step 944, where the two objects are leveled, or a tilting therebetween is measured, based on the optimum value of the force curve parameter.

The force curve analysis method in accordance with embodiments disclosed herein allow simultaneous quantitative knowledge of planarity and force. As adapted for automation, it provides real-time, in situ information regarding force-feedback and planarity-feedback. As such, this enables the unprecedented ability to pattern on non-flat surfaces, since the planar-feedback mechanism can adapt in-process to re-level the system. This could include multiple substrates at different planarities, substrates with significant bow or debris, or even spherical surfaces.

An exemplary automatic, adaptive leveling method is illustrated in the flowchart of FIG. 9B. In step 950, a prediction can be made regarding the force-distance curve, distance-distance curve, force-time curve, or distance-time curve. In step 952, a distance is varied based on the prediction. In step 954, a force curve parameter is obtained. In step 956, leveling is obtained between two objects, for example, using iterative methods illustrated in FIG. 9A. The tilting and/or distance between the two objects can change over time. Thus, in step 958, the steps of 952 and 954 are repeated so that the force curve parameter can be obtained in real time. In step 960, it is determined based on the in situ force curve parameter calculation/measurement whether the tilting has changed. If so, the leveling step 956 is repeated to obtain a new, real time leveling.

### Load Cell Chassis

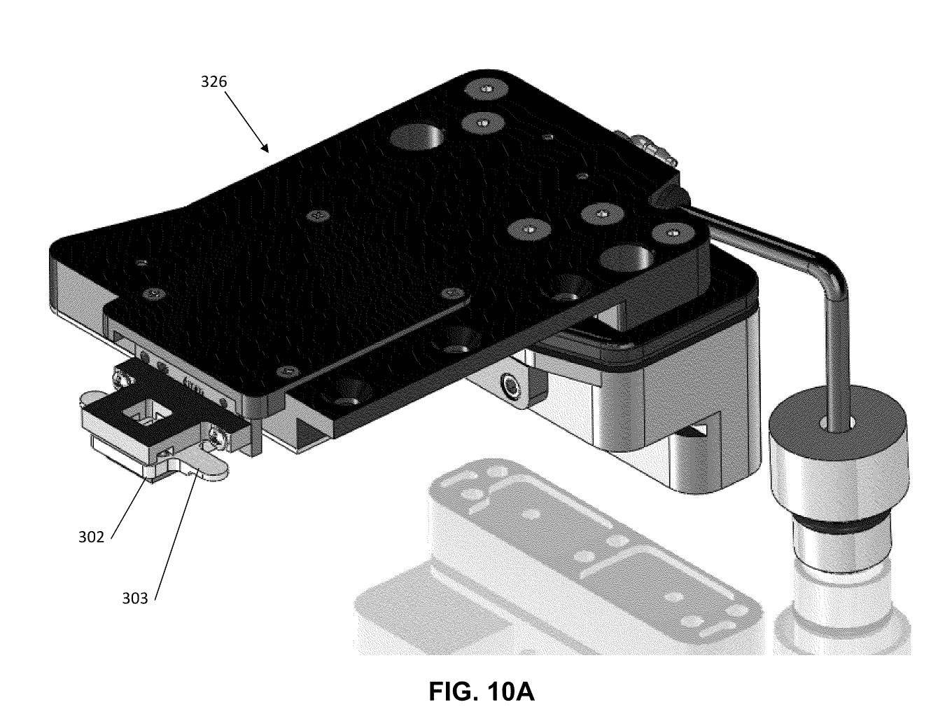

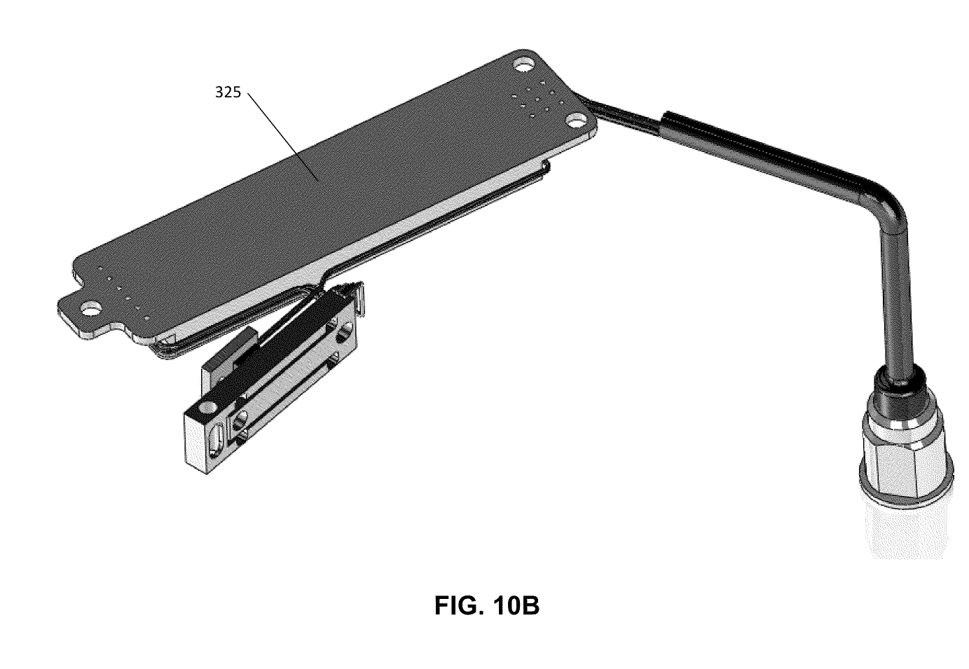

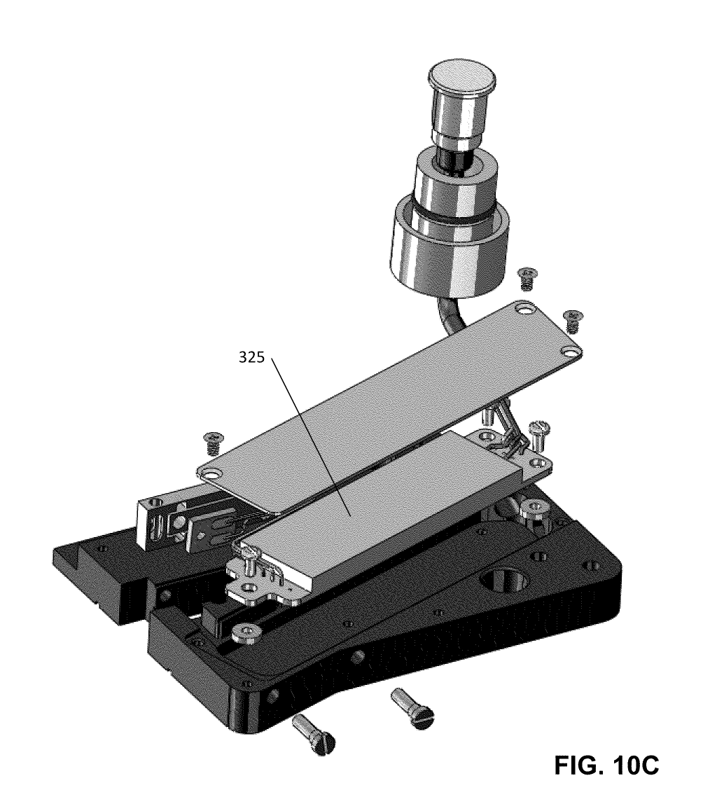

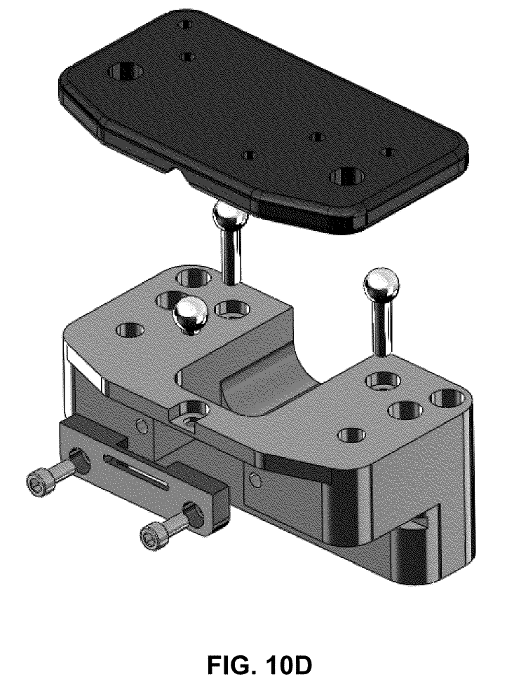

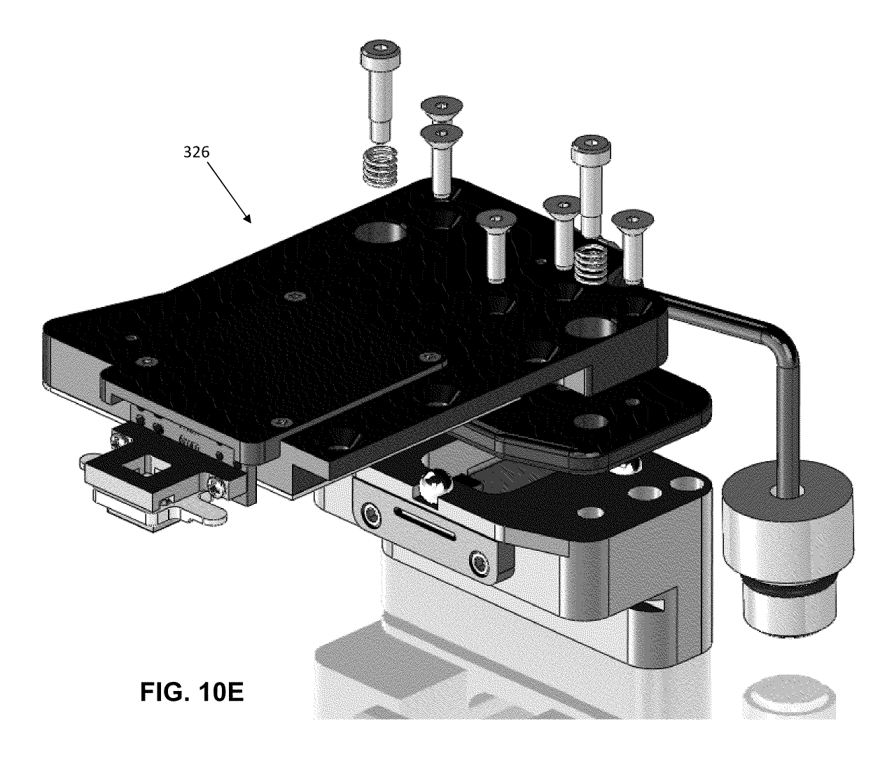

A cell chassis 326 is shown in detail in FIGS. 10A-10E, where the array 302 is mounted on an array handle 303 on the chassis 326. The apparatus may also include a load cell digitizer 325, as shown in FIG. 10B. The load cell digitizer 325 can convert the signal from a force sensor into a signal that is readable by the controller. The load cell digitizer 325 may, for example, be a Mantracourt Model DSCH4ASC Digitizer, available from Mantracourt Electronics, Ltd. The load cell digitizer 325 is preferably isolated as much as possible from all sources of noise. The load cell digitizer 325 can receive power from battery source, such as a 12V lantern battery. The load cell digitizer 325 may, alternatively, receive power from a non-battery low-noise power supply, or any other suitable power supply. The load cell digitizer 325 may be located in the load cell chassis 326, as shown in FIG. 10C.

### Examples of Integral as Force Curve Parameter

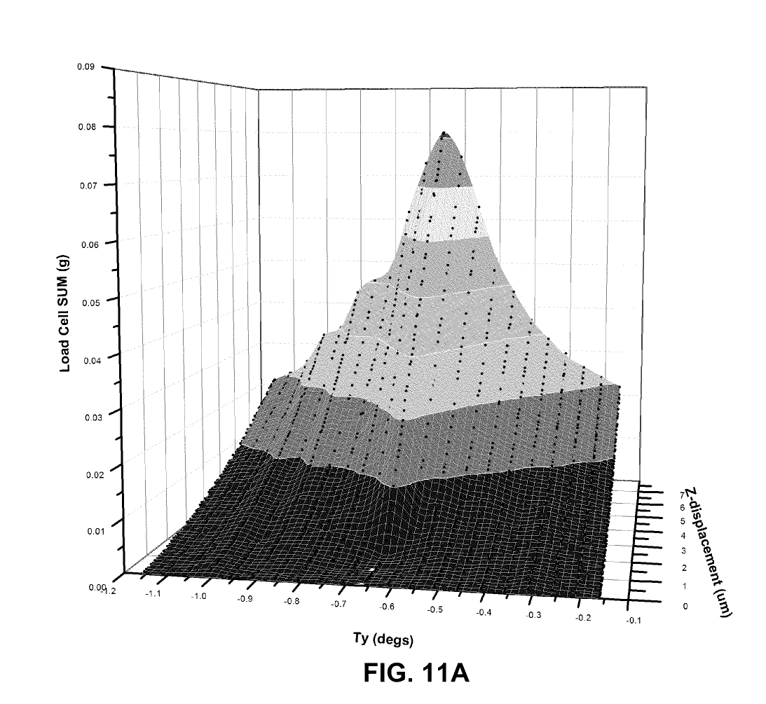

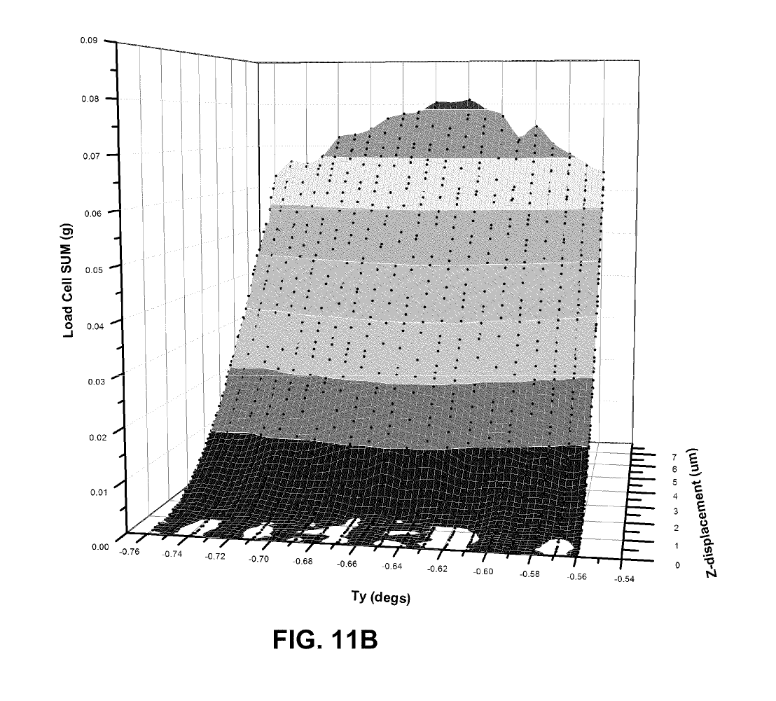

FIG. 11A illustrates a three-axis plot of the force-distance curves across a range of values of the tilt parameter T_{y}. While FIG. 11A, as well as FIGS. 11B-19 express the force in terms of mass units (g), in general the force could be expressed in terms of force units, such as Newtons, as would be recognized by one skilled in the art. The three axes are the force distance curve labeled Load Cell Sum, the Z displacement, and the tilt parameter T_{y}. The data was obtained for a 48 pen 1-D (one-dimensional) array with silicon nitride tips, a spring constant of ˜2.6 N/m, and with an X direction width of 3168 μm. The force data for FIG. 11A, as well as FIG. 11B, was obtained by driving the array in a stepwise manner. The tilt parameter T_{y} sweep range in FIG. 11A was −1.15 to −0.15 degrees with a tilt parameter resolution (increment) of 0.05 to 0.10 degrees.

Once the force curve over a displacement range for a particular tilt parameter, the force curve integral may be readily determined by integrating the force over the displacement range. As noted above with respect to the leveling automation of FIG. 9A, the integral is determined over a same displacement range for the particular tilt parameter, where the displacement for determining the integral for the particular tilt parameter starts from the point where the scale starts to read a load measurement, which is the zero displacement point for that tilt parameter. For the force curve data of FIG. 11A, the maximum value of the integral occurs for a tilt parameter T_{y} value of about −0.66 degrees.

FIG. 11B illustrates a three-axis plot similar to that of FIG. 11A, but for a tilt parameter sweep with a finer tilt parameter resolution and smaller tilt parameter range. Specifically, in FIG. 11B, the tilt parameter T_{y} sweep range was −0.76 to −0.56 degrees with a tilt parameter resolution (increment) of 0.01 degrees. The peak value of the integral for the force data in FIG. 11B occurs for a tilt parameter T_{y} value of between about −0.66 and −0.064 degrees. Thus, FIGS. 11A and 11B collectively illustrate a coarser tilt parameter sweep (FIG. 10), followed by a finer tilt parameter sweep (FIG. 11B).

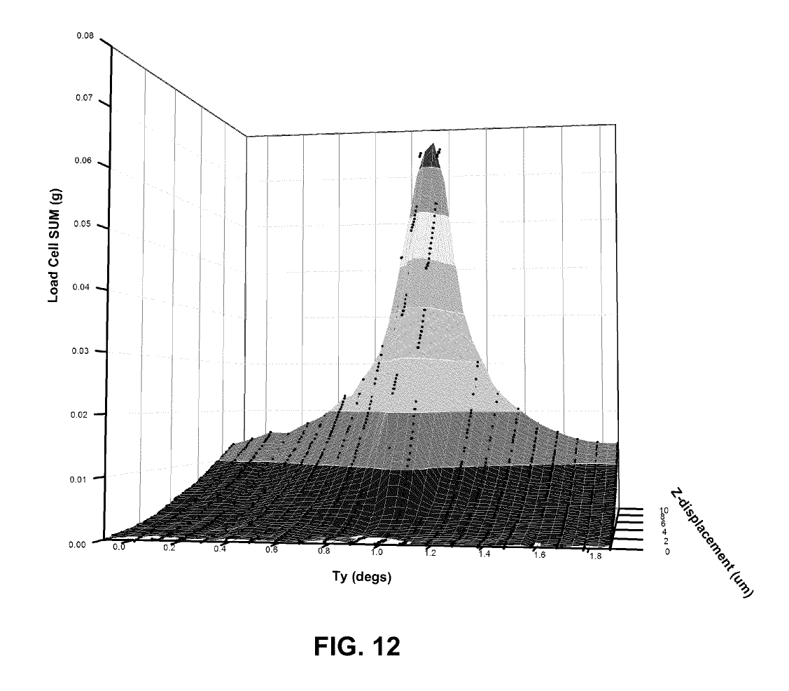

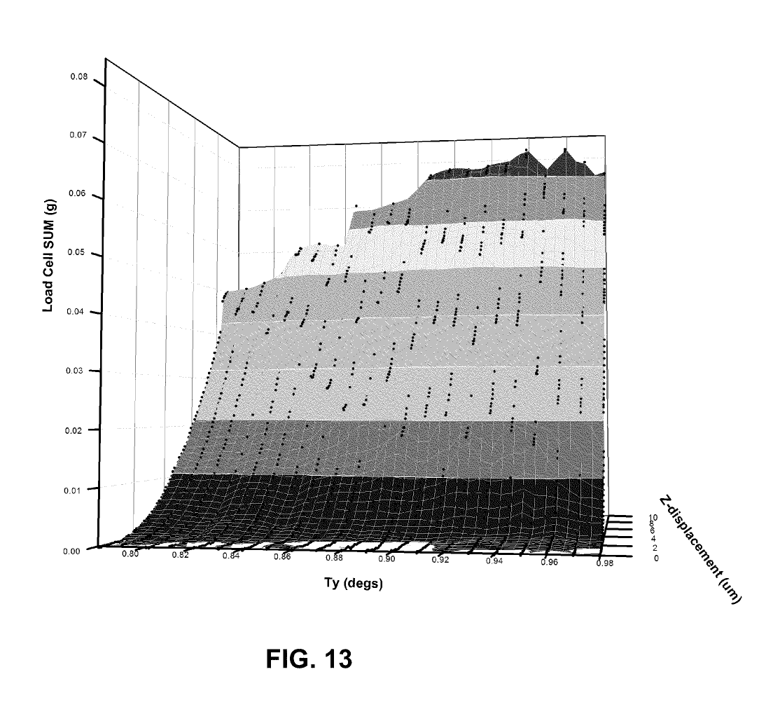

FIGS. 12 and 13 respectively illustrate three-axis plots for a coarser and finer tilt parameter sweep, where the array is driven in a continuous rather than a stepwise manner. In a similar fashion to FIGS. 11A and 11B, the data was obtained for a 48 pen 1-D (one-dimensional) array with silicon nitride tips, a spring constant of ˜2.6 N/m, and with an X direction width of 3168 μm. For the coarser sweep in FIG. 12, the tilt parameter T_{y} sweep range was −0.1 to 1.9 degrees with a tilt parameter resolution (increment) of 0.05 to 0.10 degrees. For the force data of FIG. 12, the maximum value of the integral occurs for a tilt parameter T_{y} value of about 1.0 degrees. For the finer sweep in FIG. 13, the tilt parameter T_{y} sweep range was 0.78 to 0.98 degrees with a tilt parameter resolution (increment) of 0.01 degrees. For the force data of FIG. 13, the maximum value of the integral occurs for a tilt parameter T_{y} value of about 0.94 degrees.

Data acquisition for a continuously driven stage (as for FIGS. 12 and 13) may have benefits over that for a stepwise driven method. Obtaining data for a continuously driven stage may increase the analysis speed. In particular, the same amount of data may be acquired in a shorter amount of time. Further, for data collected for a continuously driven array, a larger amount of data may be acquired per unit time or unit distance. Thus, the force curves obtained may beneficially have a denser number of data points than that for a stepwise driven method for the same or even shorter acquisition time.

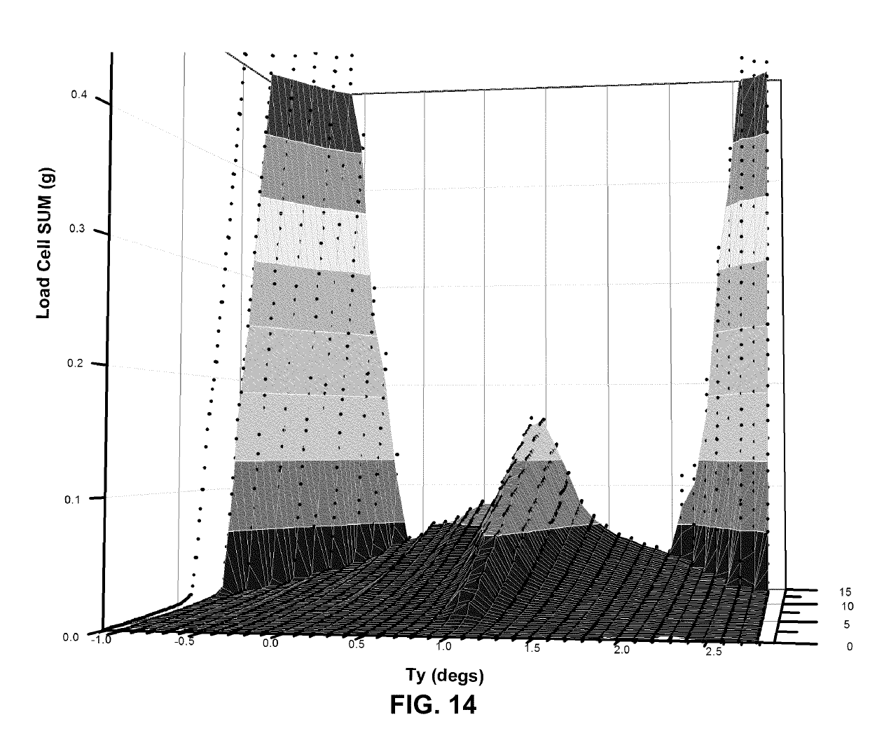

FIGS. 14-17 illustrate the concept of removing “wings” from the data in the case where the substrate surface comes into contact with the edge of the chip prior to coming in contact with the tips. In FIGS. 14, 16 and 17, in a similar fashion to FIGS. 11A and 11B, the data was obtained for a 48 pen 1-D (one-dimensional) array with silicon nitride tips, a spring constant of ˜2.6 N/m, and with an X direction width of 3168 μm.

FIG. 14 illustrates a three-axis plot for the case where the substrate surface comes into contact with the edge of the chip prior to coming in contact with the tips. The contact of the substrate surface with the edge of the chip manifests in the form of “wings” i.e., very large and sharply rising values of the force on the sides of the plot. In FIG. 14, the wings occur in a tilt parameter T_{y} range of about −1.0 to −0.1 degrees and 2.0 to 2.8 degrees.

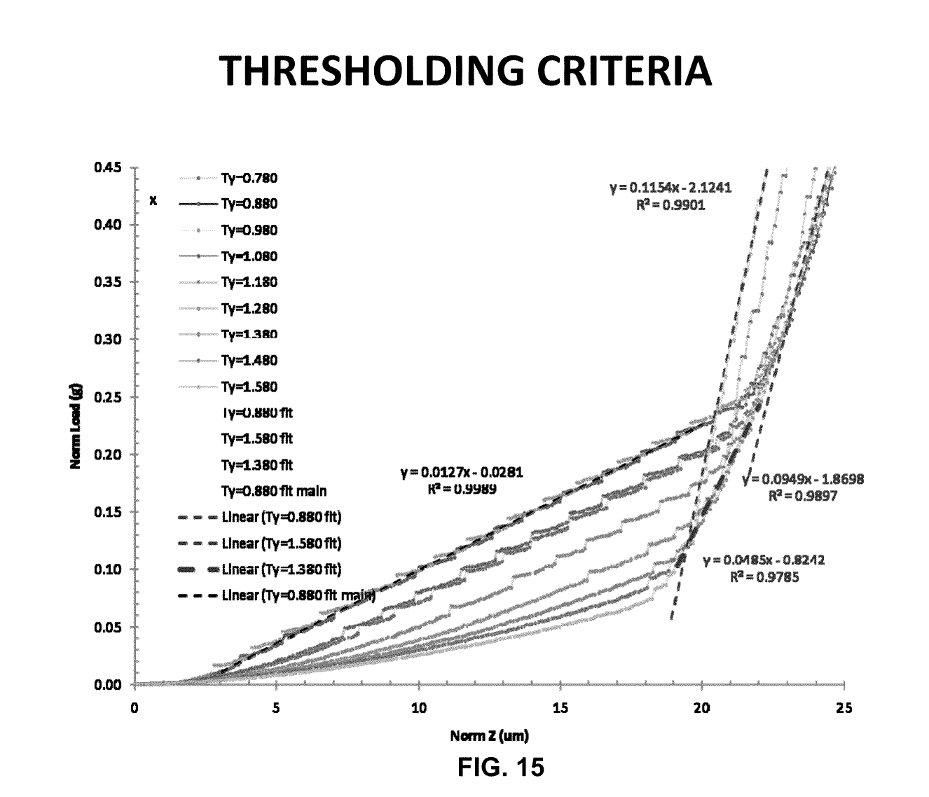

The anomalous wings may be removed by discounting data in the wing region by setting a threshold slope, where if the slope of the force curve integral is above the threshold slope, the data in the region where the slope is above a threshold is ignored. FIG. 15 shows the load vs. the displacement z. In general the maximum slope of the load due to the cantilevers of the array, which are compressible, will be a value X, while the slope due to load cell coming in contact will be much greater. As the load cell approaches the substrate the slope is due only to the cantilevers compressing. When the load cell contacts the substrate there will be a large load component due to the contact. Thus, any data where the slope approaches that due to the load cell contact should be truncated. FIG. 15 shows on the right side of the graph data which has a slope above the threshold, where the data about the threshold should be rejected and truncated.

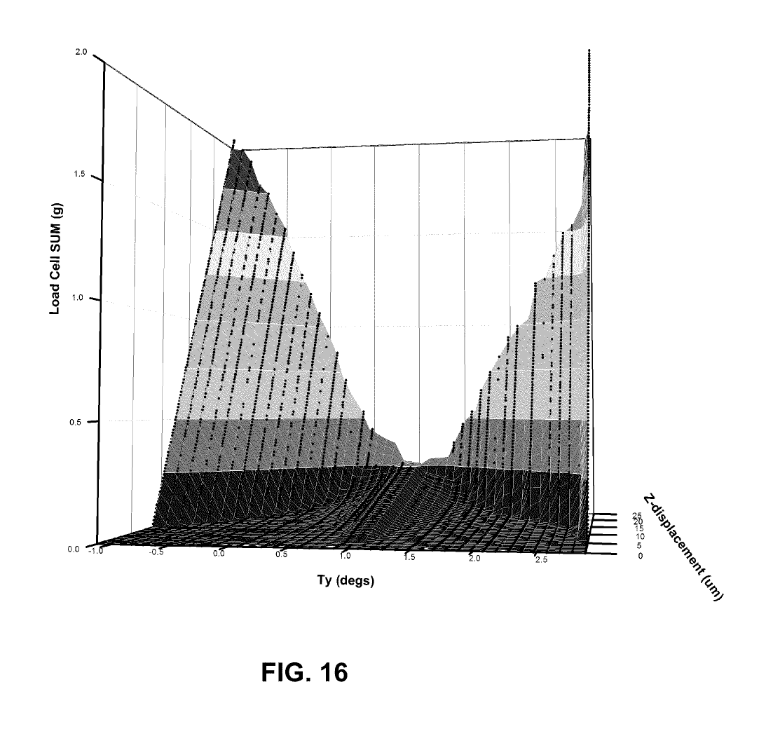

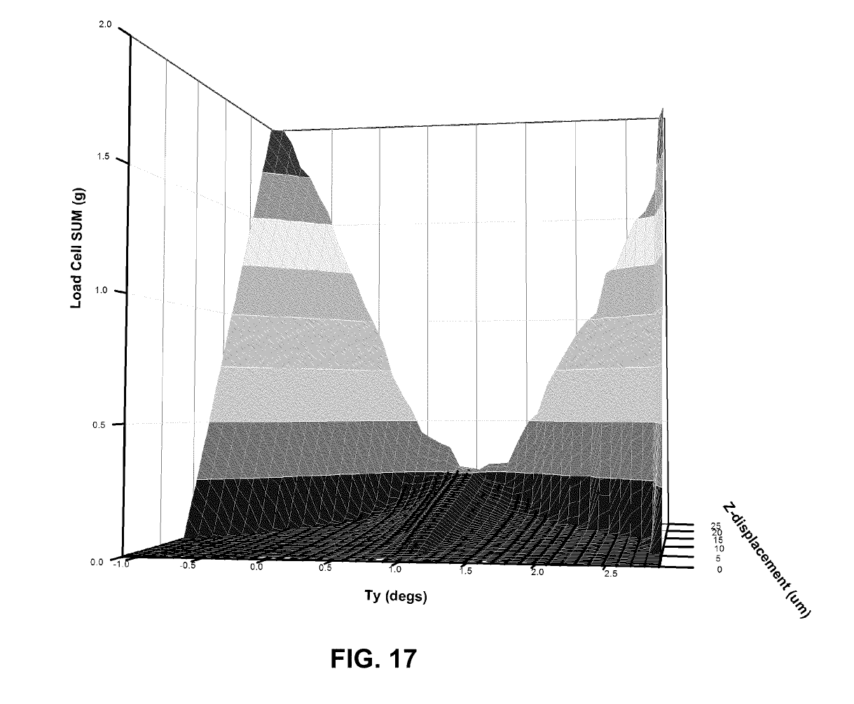

FIGS. 16 and 17 respectively illustrate the case where the data has wings, and where the data has been truncated to remove the wings. FIG. 16 illustrates the data of FIG. 14 where the scale for the force has been increased to show the height of the wings. FIG. 17 illustrates the truncated data where the wings have been removed based on a slope being above a threshold.

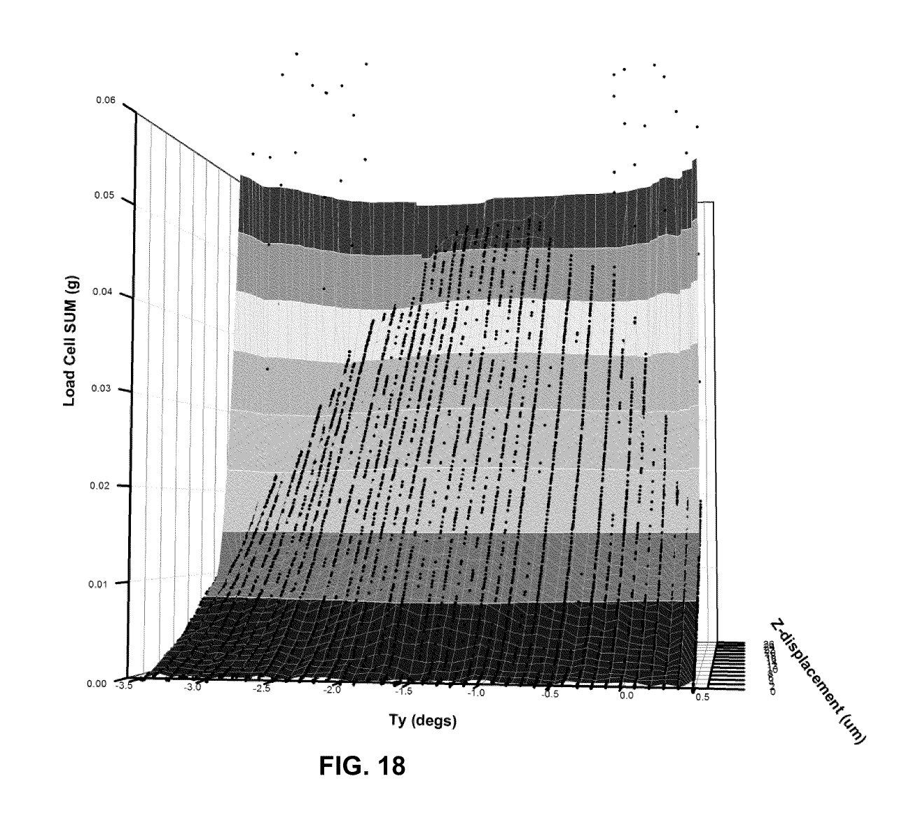

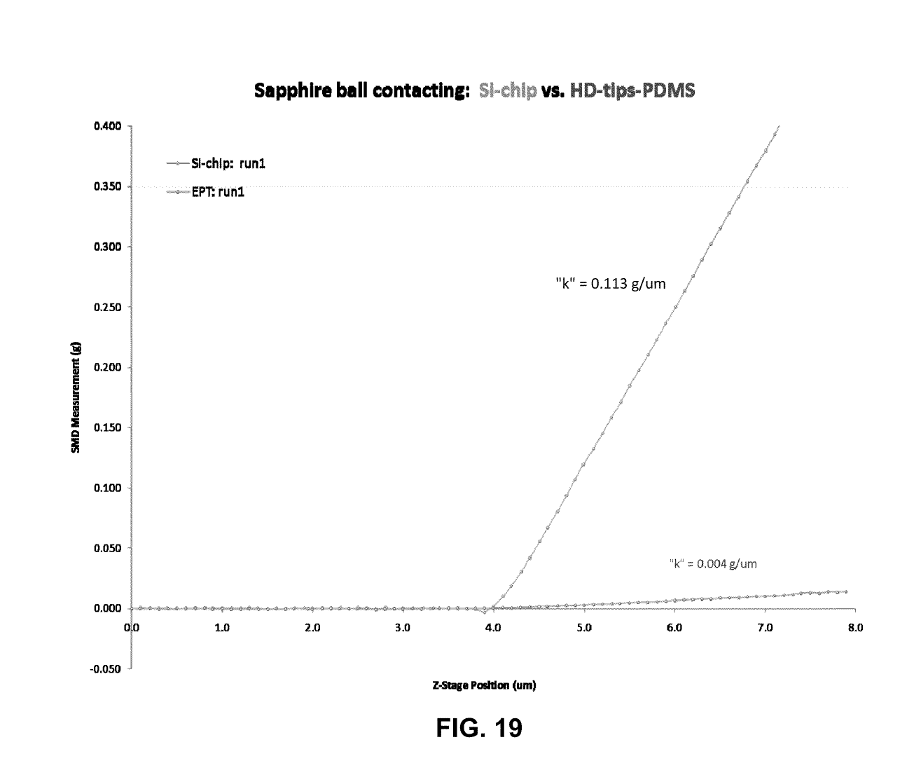

FIG. 18 illustrates a three-axis plot where the data was obtained for a 12 pen 1-D array with an X direction width of 792 μm as compared to the longer 48 pen 1-D array with an X direction width of 3168 μm for FIGS. 11A-14, 16 and 17. The tip parameters for the FIG. 18 data were the same as for FIGS. 11A-14, 16 and 17. The tilt parameter T_{y} sweep range was −3.5 to 0.5 degrees. For the force data of FIG. 18, the maximum value of the integral occurs for a tilt parameter T_{y} value identified as being about −1.7 degrees. The peak value of the integral, however was less pronounced and further down “in the noise” than that for the examples with the longer 48 pen 1-D array with wider X direction width of 3168 μm. The peak being further in the noise may be due to the reduced collective k of the shorter narrower array, which is about 25% of that of the longer wider array. In addition to the length and width of the array, the collective k value will also depend on the softness of the tips. FIG. 19 illustrates k values as determined with contact to a sapphire ball for silicon chips vs. the softer PDMS chips, where the PDMS chips have a significantly smaller k value. In general, the best results are for a system with longer array width and length and stiffer tips.

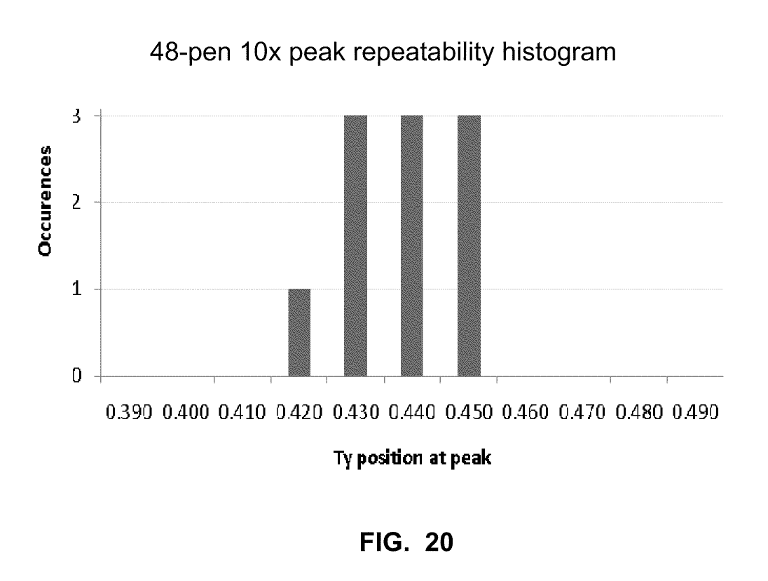

The repeatability of the identification of the tilt parameter T_{y} based on a peak force curve integral is illustrated in the histogram of FIG. 20, where the array parameters were the same as that for FIG. 11A. After an initial coarse sweep of the tilt parameter with, a fine sweep with a tilt parameter resolution (increment) of 0.01 degrees was performed 10 times for a tilt parameter range of 0.38 to 0.58 degrees. As shown in the histogram the peak detection precision is about ±0.01 degrees.

### Contact Measurement Precision

Contact measurement precision is defined as the system's ability for the array to contact the substrate and exceed a given load threshold, thus recognizing contact. The slope threshold discussed above is not the same as the contact threshold. The Z-position at which this contact threshold is crossed may be recorded. When performed many times, a statistical spread of Z-positions may be created. The standard deviation of this statistical spread is the contact measurement precision. Thus, the lower the contact measurement precision, the better the results.

Two experimental requirements dictate the necessary contact measurement precision of the system: (1) intended dot size and (2) acceptable coefficient of variation (“CV”). The CV is the degree to which printed dot sizes vary due to the tips being unlevel. Thus, the CV can be determined using the equation:

$$CV = \frac{σ}{μ}$$

where σ is the standard deviation of the dot size and μ the average dot size.

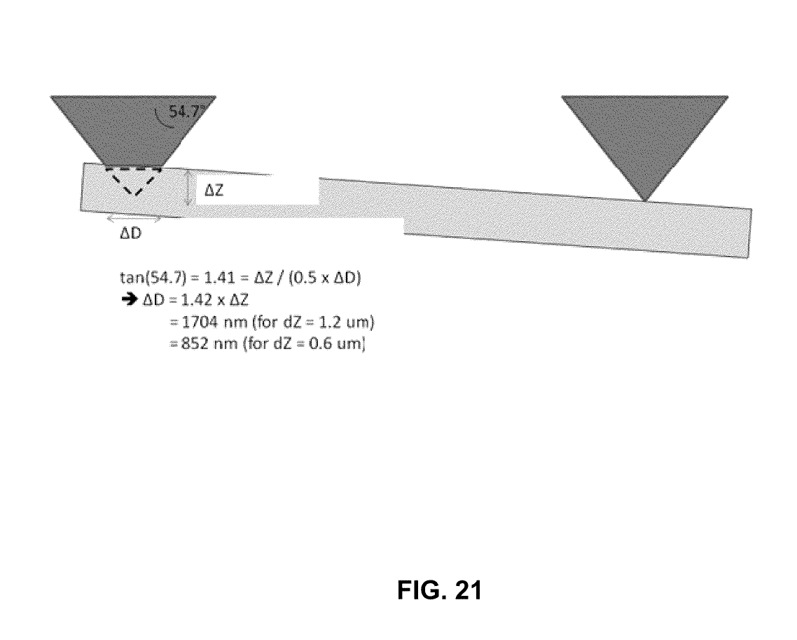

FIG. 21 depicts two tips in contact with a substrate, where there is a planar offset of the tips with respect to the substrate. In FIG. 21, it is assumed that any degree of non-planarity translates into a commensurate compression of the tip such that the footprint of the tip is approximated by the truncated triangle shown. Furthermore, it is assumed that the tips do all of the compressing first, so that virtually all of the Z-stage travel is absorbed by the deformation of the tips.

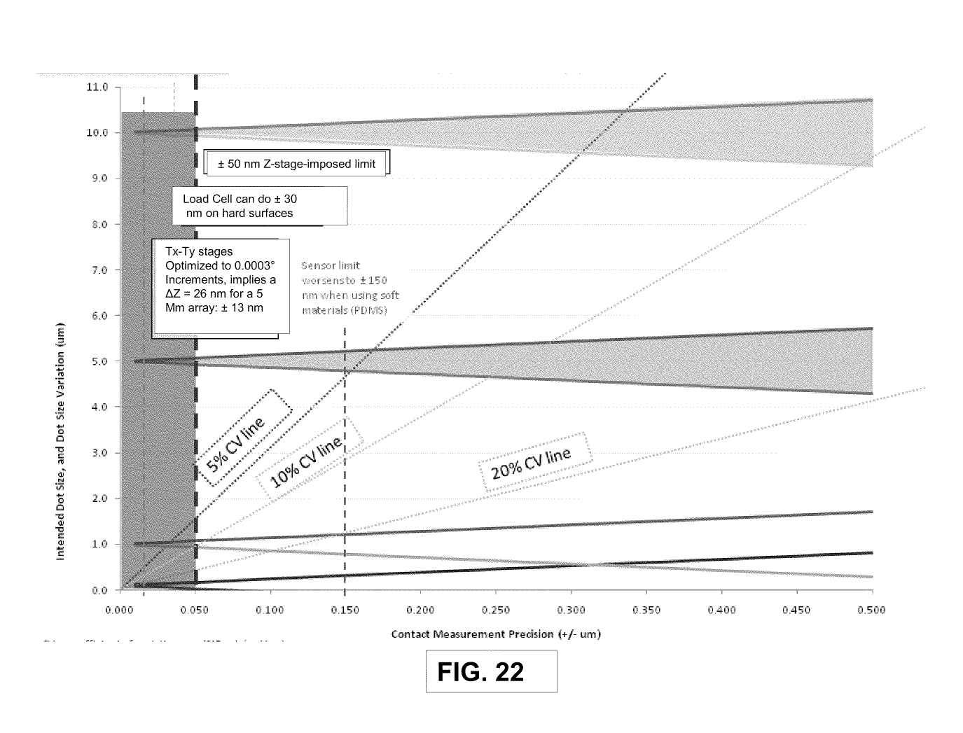

FIG. 22 is a graph showing the contact measurement precision required to obtain an intended dot size. Several restraints may determine the minimum possible contact measurement precision. One such restraint is the minimum angle by which the Z-stage may be adjusted (tip and tilt angles). For example, if the minimum angle by which the Z-stage can be adjusted is 0.0003° and the array is 5 μm wide, the minimum possible contact measurement precision that can be achieved is ±13 nm, as determined by the equation:

CMPₘᵢₙ=5 tan(0.0003).

A second restraint is the sensor detection limit, which is the minimum distance that the Z-stage must travel while in contact with the array before it can be certain that contact has been made. The restraint is largely affected by the noise floor and the signal-to-noise ratio of the load cell, as well as the materials of the array and the substrate. If the load cell signal is very noisy, it is difficult to know what is a noise spike an what represents real contact between the array and the substrate. For a given noise level of a load cell, a hard material is easier and faster to detect than a soft one. In FIG. 22, for example, the sensor detection limit is shown to be ±30 nm for hard surfaces and ±150 nm for a soft surface.

When the actuator is configured to move the Z-stage in a stepwise motion, one restraint is the Z-stage increment, which is the minimum distance by which the Z-stage may be moved in a vertical direction. The minimum measurement precision is one half the minimum Z-stage increment. FIG. 22 shows the Z-stage imposed limit for a Z-stage having a minimum increment of 100 nm. Thus, in this case, the Z-stage imposed limit of the contact measurement prevision is ±50 nm. However, this restraint is largely eliminated by using continuous motion of the Z-stage.

When the actuator is configured to move the Z-stage in a continuous motion, one restraint, not shown in FIG. 22, is the sampling rate or sampling period, which determines how quickly the controller can correlate the movement of the Z-stage with the force measured by the force sensor.

As can be seen in FIG. 22, for a given intended dot size, the dot size variation across the printed area increases linearly as the contact measurement precision gets poorer (i.e. larger). This is shown by the horizontally expanding triangles on the graph. The diagonal CV lines are just a few representations of where intended dot size and CV intersect to dictate a necessary contact measurement precision. For example, to create a 5 μm dot with no worse than 10% CV, a contact measurement precision of at least ±265 nm is required. Thus, it is desirable to operate on the left side of the graph, though this may be limited by the restraints discussed above.

1-15. (canceled)

16. An apparatus configured to level an array of microscopic pens relative to a substrate surface, the apparatus comprising:
an actuator configured to drive one of the array or the substrate surface to vary at least one of a first relative distance or a relative tilting therebetween over time;
one or more force sensors configured to measure a force between the array and the substrate surface; and
a device configured to calculate a force curve parameter of a curve of one of the force or a second distance over the first distance or time;
wherein the apparatus is configured to perform at least one of:
leveling the array relative to the substrate surface by varying a relative tilting between the array and the substrate surface based on the force curve parameter; or
measuring the relative tilting based on the force curve parameter.

17. The apparatus of claim 16, wherein the force curve parameter is an integral of the force or the second distance over the first distance or time for a predetermined displacement range.

18. The apparatus of claim 17, wherein the integral is a stepwise integral of the force or the second distance over the first distance or time, where the first distance or time is varied in a stepwise fashion.

19. The apparatus of claim 17, wherein the integral is a continuous integral of the force or the second distance over the first distance or time, where the first distance or time is varied in a stepwise fashion.

20. The apparatus of claim 16, wherein the array is a 1-D array.

21-26. (canceled)

27. The apparatus of claim 16, wherein the array of pens comprise at least one of tips disposed on cantilevers, AFM tips disposed on microcantilevers, or elastomeric polymer tips.

28-29. (canceled)

30. The apparatus of claim 16, wherein the one or more force sensors comprise:
a first stage configured comprising:
a precision beam balance; and
a sensitive spring or flexure; and
a second stage comprising:
a higher force capacity spring or flexure; and
an integrated capacitive sensor configured to monitor a movement of the array.

31. The apparatus of claim 16, wherein the force sensor comprises at least one of:
a load cell;
a capacitive element;
an inductive element;
a piezoelectric element;
a cantilever beam;
an optical encoder;
a strain gauge;
a load transducer;
a linear velocity displacement transducer;
a laser triangulation sensor; or
a confocal sensor.

32. The apparatus of claim 16, further comprising a device configured to measure the distance between the array and the substrate surface.

33. The apparatus of claim 16, further comprising a controller configured to:
iteratively vary the distance; and
adjust the tilting until a maximum of the force curve parameter is achieved.

34. The apparatus of claim 16, further comprising an enclosure configured to enclose at least the array and to keep an inside temperature at a constant temperature higher than an ambient temperature.

35. (canceled)

36. The apparatus of claim 16, wherein the array of pens is inked with a patterning ink to be transferred to the substrate surface.

37. The apparatus of claim 16, wherein the distance is variable for at least 1 nm.

38. (canceled)

39. A method comprising:
varying at least one of a first relative distance and a relative tilting over time between a first object and a second object;
obtaining a force curve parameter of a curve of one of the force or a second relative distance between the first and second objects over the first relative distance or over a time; and
based on the force curve parameter, adjusting a relative tilting between the first and second objects or measuring the relative tilting.

40. The method of claim 39, wherein the force curve parameter is an integral of the force or the second distance over the first distance or time for a predetermined displacement range.

41. (canceled)

42. The method of claim 40, wherein the integral is a continuous integral of the force or the second distance over the first distance or time, where the first distance or time is varied in a stepwise fashion.

43. The method of claim 40, further comprising:
calculating a slope of the curve of one of the force or the second relative distance over the first relative distance or time;
determining if the slope is greater than a threshold slope; and
disregarding data of the force or the second relative distance when the slope is greater than a threshold slope.

44. The method of claim 43, further comprising:
truncating the data of the curve when the slope is greater than the threshold slope.

45. The method of claim 44, further comprising:
after truncating the data, finding a maximum of the integral among integrals at a plurality of relative tilting angles between the first and second objects.

46. The method of claim 39 further comprising:
(a) obtaining a plurality of force curve parameters at a plurality of distances between the first and second objects at a first resolution and a first range of tilt parameters;
(b) determining a first maximum of the force curve parameter from among the force curve parameters at the first resolution;
(c) obtaining another plurality of force curve parameters at a plurality of distances between the first and second objects at a second resolution of tilt parameters greater than the first resolution and a second range of tilt parameters smaller than the first range; and
(d) determining a second maximum of the force curve parameter from among the another force curve parameters at the second resolution.

47. The method of claim 39, further comprising leveling the first and second objects based on the force curve parameter.

48. The method of claim 39, wherein said obtaining a force curve parameter comprises measuring a force between the first and second objects at a plurality of distances.

49. The method of claim 39, wherein said obtaining a force curve parameter comprises:
varying the distance at a predetermined rate; and
measuring a force between the first and second objects at a plurality of times.

50. The method of claim 39, wherein said obtaining a force curve parameter comprises:
varying the distance at a constant rate;
measuring a force between the first and second objects at a plurality of times; and
calculating a force curve parameter of the force over time.

51. The method of claim 39, wherein the first object comprises an array of tips defining a first substantially flat plane, and wherein the second object comprises a substrate having a substantially flat surface, the method further comprising:
leveling the first substantially flat plane and the substantially flat surface based on the force curve parameter; and
printing a pattern on the substantially flat surface using the array of tips.

52. The method of claim 39, wherein the first object comprises:
a backing; and
an array of tips disposed over the backing; and
wherein at least one of the backing, the tips, or the second object is compressible.

53. The method of claim 39, wherein the first object comprises:
a backing; and
an array of cantilevers having tips thereon and disposed over the backing; and
wherein the cantilevers are flexible.

54. The method of claim 39, further comprising finding a maximum of the force curve parameter among force curve parameters at a plurality of relative tilting angles between the first and second objects.

55. The method of claim 54, wherein the force curve parameter is an integral of the force or the second distance over the first distance or time.

56. The method of claim 39, further comprising:
obtaining a trend of the force curve parameter versus the relative tilting; and
if the force curve parameter decreases, adjusting the relative tilting in an opposite direction.

57. The method of claim 39, further comprising:
(a) obtaining a plurality of force curve parameters at a plurality of distances between the first and second objects;
(b) adjusting a relative tilting between the first and second objects;
(c) repeating the steps of (a) and (b); and
(d) mapping the force curve parameters as a function of the relative tilting and the distances.

58. The method of claim 39, further comprising:
(a) obtaining a plurality of force curve parameters at a plurality of distances between the first and second objects;
(b) adjusting a relative tilting between the first and second objects, wherein the relative tilting is in one of x or y directions;
(c) repeating the steps of (a) and (b); and
(d) mapping the force curve parameters as a 2-D function of the relative tilting in both x and y directions and the distances.

59. The method of claim 39, further comprising:
(a) obtaining a plurality of force curve parameters at a plurality of distances between the first and second objects;
(b) adjusting a relative tilting between the first and second objects, wherein the relative tilting is in one of x or y directions;
(c) repeating the steps of (a) and (b);
(d) mapping the force curve parameters as a 2-D function of the relative tilting in both x and y directions and the distances; and
(e) obtaining a maximum of the force curve parameter from the 2-D mapping.

60. The method of claim 39, further comprising:
(a) obtaining a plurality of force curve parameters at a plurality of distances between the first and second objects;
(b) adjusting a relative tilting between the first and second objects, wherein the relative tilting is in one of x or y directions;
(c) repeating the steps of (a) and (b);
(d) mapping the force curve parameters as a 2-D function of the relative tilting in both x and y directions and the distances;
(e) obtaining a maximum of the force curve parameter from the 2-D mapping;
(f) adjusting the relative tilting to the position corresponding to the maximum.

61. The method of claim 39, further comprising measuring a force between the first and second objects using one or more force sensors, and wherein the force is in the range of 1 pN to 1 N.

62-63. (canceled)

64. The method of claim 39, further comprising automatically leveling the first and second objects relative to each other by finding a maximum in the force curve parameter among a plurality of relative tilting, wherein said automatically leveling comprises iteratively varying the distance and adjusting the tilting until a maximum of the force curve parameter is achieved.

65. (canceled)

66. The method of claim 39, further comprising:
measuring forces at a plurality of horizontal positions arranged geometrically symmetric about a center of the array; and
determining a planarity between the first and second objects based on a differential between the measured forces.

67. The method of claim 39, further comprising:
monitoring an environmental change including at least one of a temperature, Rh, or a vibration; and
compensating for the environmental change.

68. The method of claim 39, further comprising maintaining a substantially constant temperature for the first and second objects, wherein the constant temperature is higher than an ambient temperature.

69. (canceled)

70. The method of claim 39, further comprising predicting at least one of:
a compression characteristic of one of the first or second object; or
a resulting planarity between the first and second objects.

71. The method of claim 39, further comprising, after substantially leveling the first and second objects:
obtaining another force curve parameter; and
immediately adjusting a relative tilting between the first and second objects if the other force curve parameter indicates that the relative tilting has changed.

72. The method of claim 39, further comprising:
continuously adjusting the relative tilting based on a real time feedback of the force curve parameter.

73-79. (canceled)

80. A method comprising:
providing at least one array of tips coated with an ink,
providing at least one substrate,
moving at least one of the tips or the substrate so that ink is transferred from the tips to the substrate, wherein the moving comprises the step of leveling the array and the substrate with use of force-distance measurements including a calculation of a force curve parameter of a force curve.

81. The method of claim 80, wherein the force curve parameter is an integral of the force over a distance or time for a predetermined displacement range.

82. The method of claim 80, wherein the tips are nanoscopic tips, scanning probe microscope tips, atomic force microscope tips, or elastomeric tips.

83-86. (canceled)

87. The method of claim 80, wherein the array of tips is a two dimensional array of tips.

88-95. (canceled)

96. The method of claim 80, wherein the array of tips is characterized by an area of tips on the array which is at least one square millimeter.

97-98. (canceled)

99. The method of claim 80, wherein a fraction of the tips transfer ink to the substrate, and the fraction is at least 75%.

100-101. (canceled)

102. A method comprising:
providing a substrate surface;
providing at least one array of pens;
providing an actuator configured to drive one of the array and/or the substrate surface to vary a distance therebetween over time;
providing a force sensor configured to measure a force between the array and the substrate surface; and
providing a device configured to calculate a force curve parameter of a curve of the force over the distance or time;
driving at least one of the array or the substrate surface to vary the distance therebetween over time;
measuring a force between the array and the substrate surface;
calculating a force curve parameter of the force over the distance or time; and
performing at least one of:
(1) leveling the array relative to the substrate surface by varying a relative tilting between the array and the substrate surface based on the force curve parameter; or
(2) measuring the relative tilting based on the force curve parameter.

103-113. (canceled)

114. A method comprising:
predicting a force-distance relationship between a first and second objects;
varying a distance between the first and second objects based on the force-distance relationship; and
obtaining a force curve parameter of a curve of force with respect to the distance; and
based on the force curve parameter, leveling the first and second objects or measuring a relative tilting between the first and second objects.

115-117. (canceled)
